(19) United States
(12) Patent Application Publication
(10) Pub. No.: US 2012/0092337 A1
(43) Pub. Date: Apr. 19, 2012

(54) Projection Display System and Method with Multiple, Convertible Display Modes

(76) Inventor: CHE-CHIH TSAO, Arlington, MA (US)

(21) Appl. No.: 13/271,701

(22) Filed: Oct. 12, 2011

Related U.S. Application Data
(60) Provisional application No. 61/392,595, filed on Oct. 13, 2010.

(51) Int. Cl. G06T 15/00; G02B 27/22; G06F 3/041; G03B 21/14

(52) U.S. Cl. 345/419; 353/31; 359/464

(57) ABSTRACT

This invention relates in general to methods and systems of a projection display that can be used in 4 display modes: (A) as a rear-projection 2D display, (B) as a volumetric 3D (V3D) display, (C) as an auto-stereoscopic 3D (as3D) display, or (D) as a projector. Conversion among the 4 display modes requires only 1 to 3 actions of adjustment by the user. The system can further contain an integrated touch pad for direct, barrier-free interaction with 2D, as3D or V3D images. The illumination and projection of the SLM is converted between a sub-panel mode and a full-panel mode. By using the sub-panel illumination/projection mode, the system can operate in V3D, 2D and as3D modes. By using the full-panel mode, the system can operate in 2D and projector modes.

### CROSS-REFERENCE TO RELATED APPLICATIONS AND OTHER DOCUMENTS

This application claims the benefit of prior U.S. provisional application No. 61/392,595, filed Ser. No. 10/13/2010, the contents of which are incorporated herein by reference.

This invention relates to the following US patents by Tsao: U.S. Pat. No. 5,954,414, U.S. Pat. No. 6,302,542 B1, U.S. Pat. No. 6,765,566 B1, U.S. Pat. No. 6,961,045 B2, U.S. Pat. No. 7,692,605 B2, U.S. Pat. No. 7,714,803 B2, U.S. Pat. No. 7,701,455 B2, U.S. Pat. No. 7,804,500 B2, and U.S. Pat. No. 7,933,056 B2. The above documents are therefore incorporated herein for this invention by reference.

### BACKGROUND OF THE INVENTION

This invention relates in general to a projection display of multiple operation modes. This invention also relates to volumetric 3D (V3D) display, rear-projection 2D display, autostereoscopic 3D (as3D) display based on parallax barriers, and projector display.

One category of V3D display generates V3D images by rapidly moving a screen to repeatedly sweep a volume and projecting successive 2D image frames on the screen. V3D images form in the swept volume by after-image effect. One typical mode of motion is to place a screen on a slider-crank mechanism to make the screen move in reciprocation motion. Tsao U.S. Pat. No. 6,765,566 (FIG. 20) describes a different type of motion, as illustrated in FIG. 1. In principle, this is to revolve the screen 2031 about an axis 2000 and sweep a volume 2040 while keeping the screen surface always facing a fixed direction. A projector 2010 projects successive image frames onto the moving screen. For convenience, this motion is called “Rotary Reciprocating motion”.

One major application area of V3D displays is electronic gaming. Popular electronic game systems includes handheld (or portable) gaming devices (such as Nintendo DS and Sony PSP), home-based video gaming systems (such as Nintendo Wii, Sony Play Station and Microsoft XBox), and various types of business-use (arcade) gaming systems. More recently, as3D displays are used in handheld gaming devices, such as Nintendo 3DS. Therefore, existing games include 2D display games and as3D display games. V3D displays provide a new type of gaming display that enables a new type of games and new game playing experience. It is desirable for a V3D display system to be able to display 2D images and as3D images as well. Therefore, existing 2D games and as3D games can still be played on the new system.

Some gaming devices include a touch pad for user-image interaction. Therefore, it is also desirable that a V3D display system includes the capability of using a touch pad for user-image interaction. The interaction should also include interaction in V3D and as3D modes.

Some gaming devices include a 2nd display screen. Therefore, it is also desirable that a V3D display system allows the addition of a 2nd projection screen.

### BRIEF SUMMARY OF THE INVENTION

This invention describes a projection display that can be used in the following 4 display modes:
(A) as a rear-projection 2D display,
(B) as a volumetric 3D (V3D) display,
(C) as an auto-stereoscopic 3D (as3D) display, or
(D) as a projector.
   Conversion among the 4 display modes requires only 1 to 3 steps of adjustment by the user. The system can further contain a touch pad for interaction with 2D, as3D or V3D images. When desired, the system can also incorporate a 2nd display screen. One projector is used as the image source for both the main screen and the 2nd screen.

A portable display system is used as an example in order to describe the current invention. However, the described features can also be applied to a home-based system or a business-use system.

FIG. 2(a) illustrates this invention in its configuration for operations in V3D mode, 2D mode (rear projection) and as3D mode. The system includes a display unit 280 and a projector unit 260.

The display unit includes a screen 281 and a protective case 285. In V3D mode, the preferred motion of the screen is “Rotary Reciprocating motion”. By using this motion, the motion track 2811 of the screen is basically circular. The screen sweeps across a display volume 2812. Other mechanism such as a slider-crank mechanism can also be used. A small motor (not shown) can be applied to drive the motion. In 2D mode and as3D mode, the screen does not move. The surface of the screen always faces z-direction in any mode.

In order to reduce the size of the whole system, the projector unit is placed next to the display unit, as illustrated in FIG. 2(a). This position places the projector at one end of the screen. A reflector 271 folds the path of projection (295a, 295b) so that the projection beam reaches the screen from the backside 295b. The reflector 271 is attached to an extension arm 272 on a rotary joint 273. The extension arm is attached to the projector unit (or alternatively, to the display unit) on another rotary joint 274. In other words, most of the path of projection is “external” of the system package and cover. The purpose of this arrangement is to minimize the size of the whole system for portable products. The external reflector 221 can be folded down when it is not used. FIG. 2(b) illustrates a system configuration in projector mode. The external reflector assembly 270 is in folded down position. The projection beam 295 projects to an external display surface 297.

The protective cover 285 is basically transparent so that a V3D image can be viewed from almost all directions. To improve image contrast, a gray tint can be added to the transparent cover. In order not to reduce the brightness of the projection beam, the area 2851 where the projection beam passes through has no gray tint.

A “position-changing parallax barrier panel” 120 is placed on top of the cover and is parallel to the screen 281. In as3D mode, this parallax barrier panel works with projected images on the screen to provide autostereoscopic 3D images. In other modes, the parallax barrier panel is switched to off-state and is basically transparent, without affecting other performances. (See Part 2)

When desired, a transparent touch pad 283 is added to the top of the parallax barrier panel. (See Part 3)

When desired, the system of this invention allows a 2nd projection screen that can be used simultaneously with the main screen and uses the same projector as the image source. (See Part 4)

An SLM (spatial light modulator) is used as the image source in the projector unit 260. In order for illumination efficiency and display quality, the illumination and projection of the SLM is converted between a sub-panel mode and a full-panel mode. By using the sub-panel illumination/projection mode, the system can operate in V3D, 2D and as3D modes. By using the full-panel mode, the system can operate in 2D and projector modes. A mode selection switch (278) and 1 or 2 manual slide bars (277) make the conversion. The optical system design allows simple conversion mechanism and minimal number of optical component. The means of conversion includes (i) Opto-mechanical approaches and (ii) Quick (Solid-state) conversion (by a means of “Flexible Sub-panel Illumination”). (See Part 1)

This invention is described in details in the following chapters (parts):
Part 1: Convertible illumination and projection layout
Part 2: Autostereoscopic 3D Display by Position-Changing Parallax Barriers
Part 3: Methods and Systems for using touch pad for user-image interaction
Part 4: System with dual screens
   However, a multi-mode display system does not have to have all the modes described in this invention. A system can have only 2 or 3 modes. For examples, a system without a high frame rate SLM, it can still have 2D mode, as3D mode and 2D projector mode. Similarly, a system without a parallax barrier panel can still have V3D mode and 2D mode.

### BRIEF DESCRIPTION OF THE DRAWINGS

FIG. 1 illustrates a V3D display system in the prior art.

FIG. 2(a) illustrates a system of this invention with a configuration for V3D mode, 2D mode (rear projection) and as3D mode. (b) illustrates the system with a configuration for projector mode.

FIG. 3 illustrates examples of LED arrangement when Abbe illumination is used.

FIG. 4(a)-(b) illustrates the use of light pipes to change the aspect ratio of LED sources.

FIG. 5 illustrates examples of LED arrangement when Kohler illumination is used.

FIG. 6 illustrates an example of using 2 sub-panels for Pattern Illumination.

FIG. 7 illustrates the first design example of convertible optical layout of this invention.

FIG. 8 depicts examples of mechanism for convertible optical layout of this invention.

FIG. 9 illustrates the 2nd design example of convertible optical layout.

FIG. 10 illustrates the 3rd design example of convertible optical layout.

FIG. 11 illustrates the 5th design example of convertible optical layout.

FIG. 12 illustrates the 6th design example of convertible optical layout.

FIG. 13 illustrates the 7th design example of convertible optical layout.

FIG. 14(a)-(b) illustrates the 8th design example of convertible optical layout.

FIG. 15(a)-(b) illustrates the 9th design example of convertible illumination.

FIG. 16(a)-(b) illustrates the 10th design example of convertible illumination.

FIG. 17(a) illustrates the 11th design example of convertible illumination.

FIG. 17(b) illustrates the 12th design example of convertible illumination.

FIG. 18 illustrates the 13th design example of convertible illumination system using lasers.

FIG. 19 illustrates the 14th design examples of convertible illumination system using lasers.

FIG. 20 illustrates a 2-state position changing parallax barrier panel of this invention.

FIG. 21 illustrates the principle of using a 2-state position changing parallax barrier panel.

FIG. 22 illustrates the arrangement of image stripes in the field frames in the method of FIG. 21.

FIG. 23 illustrates the operating principle of a TN cell as a shutter in the prior art.

FIG. 24 illustrates the first example of the construction of an array of LC shutters as the barrier panel.

FIG. 25 illustrates the 2nd example of the construction of an array of LC shutters as the barrier panel.

FIG. 26 illustrates the 3rd example of the construction of an array of LC shutters as the barrier panel.

FIG. 27 illustrates the 1st method of a barrier panel usable in 2 directions, using a LC cell with matrix electrode configuration.

FIG. 28 illustrates the 2nd method of a barrier panel usable in 2 directions, using a rotatable plate of polarizer stripes.

FIG. 29 illustrates the 4th method of a barrier panel usable in 2 directions, using a panel of barriers in checker-board configuration.

FIG. 30 illustrates the arrangement of image units in the field frames in the method of FIG. 29.

FIG. 31 illustrates a general frame sequence.

FIG. 32 illustrates frame sequences to be used when a high frame rate SLM is used.

FIG. 33 illustrates analysis of mis-alignment.

FIG. 34 illustrates a method of alignment markers for viewing alignment in as3D mode.

FIG. 35 illustrates the effect of using wide barriers to cover border area.

FIG. 36(a) illustrates a 3-state position changing parallax barrier panel of this invention. (b) illustrates image stripes organization for field frames in the 3-state approach.

FIG. 37 illustrates the “movement” of L- and R-image stripes corresponding to the 3-state parallax barriers.

FIG. 38 illustrates “image stripe masks” with an example of original stereoscopic frame pair in the 3-state approach of this invention.

FIG. 39 illustrates examples of cross-sectional structure of different ways to integrate parallax barrier panel and touch pad of this invention.

FIG. 40 illustrates a system with a 2nd screen.

FIG. 41(a) and FIG. 42 illustrate concept of using touch area for depth control.

FIG. 41(b) illustrates the conceptual design of a “Z Stylus” capable of providing depth control.

FIGS. 43 and 44 illustrates the concept of using two fingers to pick and drop V3D images in V3D mode and in as3D mode.

FIG. 45 illustrates the concept of “virtual manipulator” using a “Z Stylus”.

### DETAILED DESCRIPTION

### Part 1: Convertible Illumination and Projection Layout

### 1.1 Pattern Illumination Basics

In a V3D display, color 2D images need to be projected (or displayed) at high frame rate in order to form V3D images of high resolution. Because most high frame rate SLMs (such as DMD and FLCD (FLCOS display)) can only display binary (B&W) pixels, displaying color V3D images presents a challenge. Tsao U.S. Pat. No. 6,961,045 describes a “Pattern Projection” technique that allows the use of only one SLM (instead of 3) to create color image frames at high frame rate. The basic idea is to divide the SLM panel into 3 sub-panels and illuminate each sub-panel with R, G and B light respectively (called Pattern Illumination). At projection, the 3 sub-panels are superimposed to become one frame. As a result, each frame can have R, G and B 3 color components (3 sub-frames), which can mix to create colors.

### 1.2 Pattern Illumination, in Kohler Illumination

There are two basic approaches in illumination design. Abbe illumination projects the light source onto the display panel. Kohler illumination projects the source into the pupil of the projection lens, rather than onto the display panel. (Ref. R. E. Fisher and B. Tadic-Galeb, Optical System Design, McGraw-Hill, NY, 2000, p. 291.)

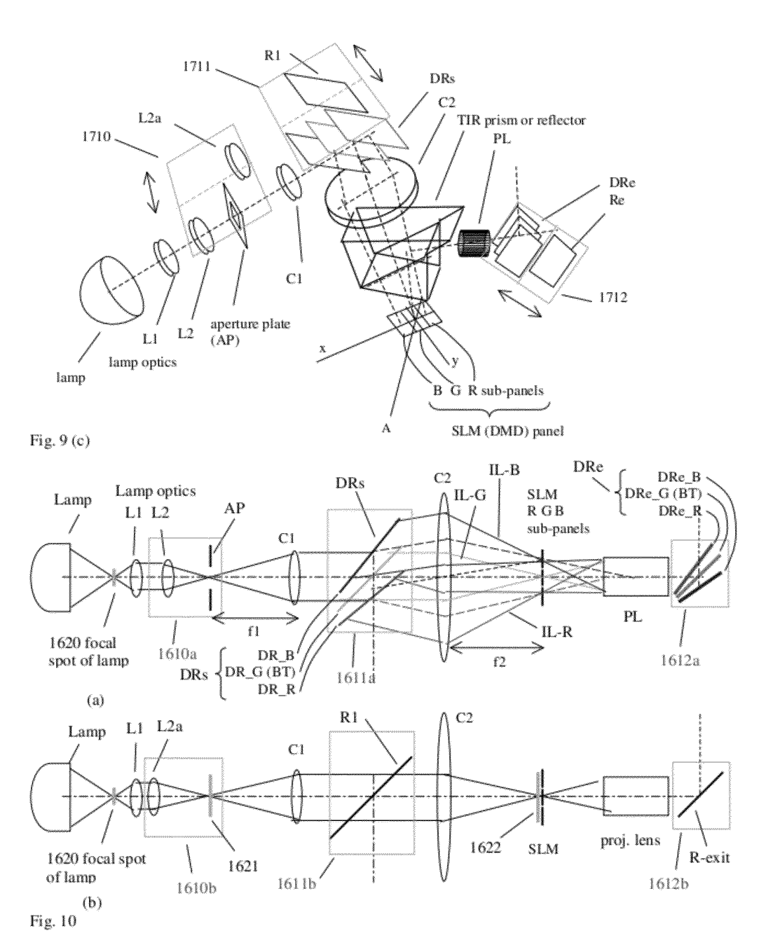

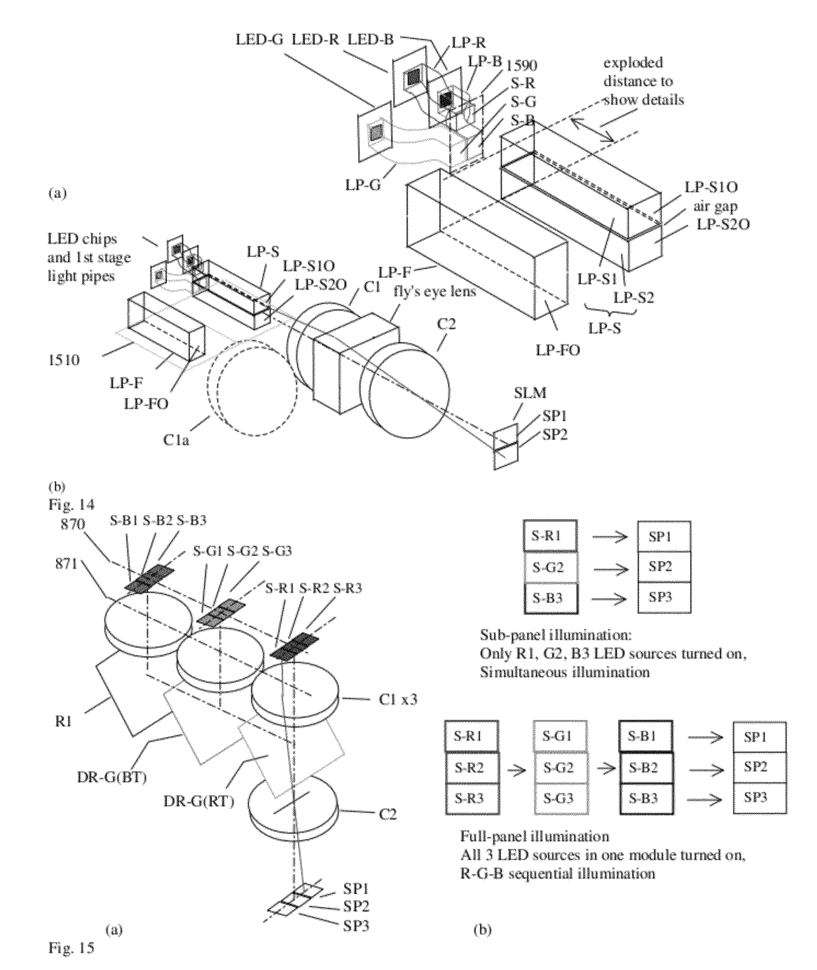

Tsao U.S. Pat. No. 6,961,045 FIG. 10a illustrates one example optical layout of Pattern Illumination using Abbe illumination. Tsao U.S. Pat. No. 6,961,045 FIG. 14 illustrates one example of Kohler illumination.

In this current invention, FIG. 9(a) illustrates an improved design of Pattern Illumination using Kohler illumination. For clarity, the design is drawn as unfolded layout. (I.e., the change of path direction due to reflection at dichroic reflectors (DRs) and at the SLM is not shown. Further, reflector (or TIR prism) between SLM and C2 is omitted.) The layout uses 2 lens (C1 and C2) to project the illumination pattern onto the SLM's sub-panels. The illumination beam illuminates the aperture plate AP to generate the projection pattern. AP is on C1's focal plane and SLM is on C2's focal plane. The lamp optics contains 2 condenser lens (L1 and L2). The key feature is that the illumination beam 921 passes the aperture AP as a converging beam, instead of a diverging beam in Abbe case. In addition, the converging point of the illumination beam 922 (which is the location of the image of the light source spot 620) is placed at or close to the center of lens C1. Further, lens C1 and the projection lens are placed approximately at the two finite conjugate points (922 and 924) of lens C2. In other words, the converging point of the illumination beam 922 is projected to the projection lens mainly by C2. In this way, the illumination beam converges at the projection lens to achieve Kohler illumination. On the other hand, the image of aperture (AP) is projected onto the SLM.

When a regular projection lens is used, Kohler illumination has a better illumination efficiency than Abbe illumination. FIG. 10(a) illustrates an example of Abbe illumination. Although a lamp is depicted in FIGS. 9 and 10, the illumination design described above is applicable to any light source.

### 1.3 Pattern Illumination, LEDs or Lasers as Light Sources

When a single white LED is used as light source, the illumination optics design is basically the same as using a single white arc lamp as light source. When LEDs of different colors (usually R, G and B) are used, the main issue is how to project light from separate LED sources of different colors onto different sub-panels.

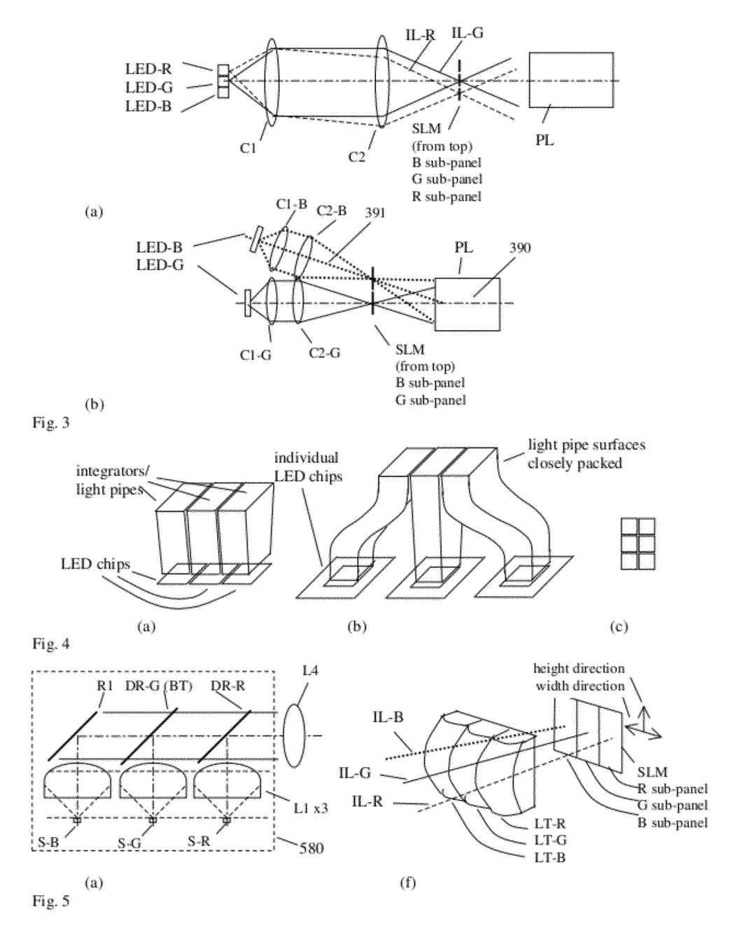

FIG. 3(a)-(b) illustrates examples of LED arrangement when Abbe illumination is used. (All in unfolded layouts. For simplicity, layout illustrates only two colors.)

If the sizes of LEDs and SLM are comparatively small relative to the diameters of optics, then the design of FIG. 3(a) can be used. Closely packed R G and B LED chips are used as the light source (R G B patterns). 2 lenses (C1 and C2) project the images of the R, G and B LEDs onto the corresponding R, G and B sub-panels in the SLM.

FIG. 3(b) is similar to FIG. 3(a) except that LEDs are separated and each primary color has its own illumination lens (C1 and C2). In addition, the optical axis of B illumination beam 391 is tilted passes the center of the B sub-panel in order to point toward the projection lens. (R illumination is the same, not shown.)

In FIG. 3(a)-3(b), the emitting areas of LED devices are used as the illumination patterns. Light pipes (or mixing rods) can be used to capture light from LEDs and reshape the aspect ratio of the illumination pattern. Light pipes can also be used to bring light from separate, individual LED devices to form closely packed new sources. FIGS. 4(a) and (b) illustrate the ideas. Alternatively, 6 LED devices (2R 2G 2B) can be used for a different aspect ratio, as shown in FIG. 4(c).

Accordingly, in this invention, the term “LED light source” includes a light source formed by one or more LEDs devices or by one or more LED devices with a light pipe system. Conceptually, the term also include any other kind of light source with small emitting area with diverging emitting angle, not limiting to “light emitting diode”.

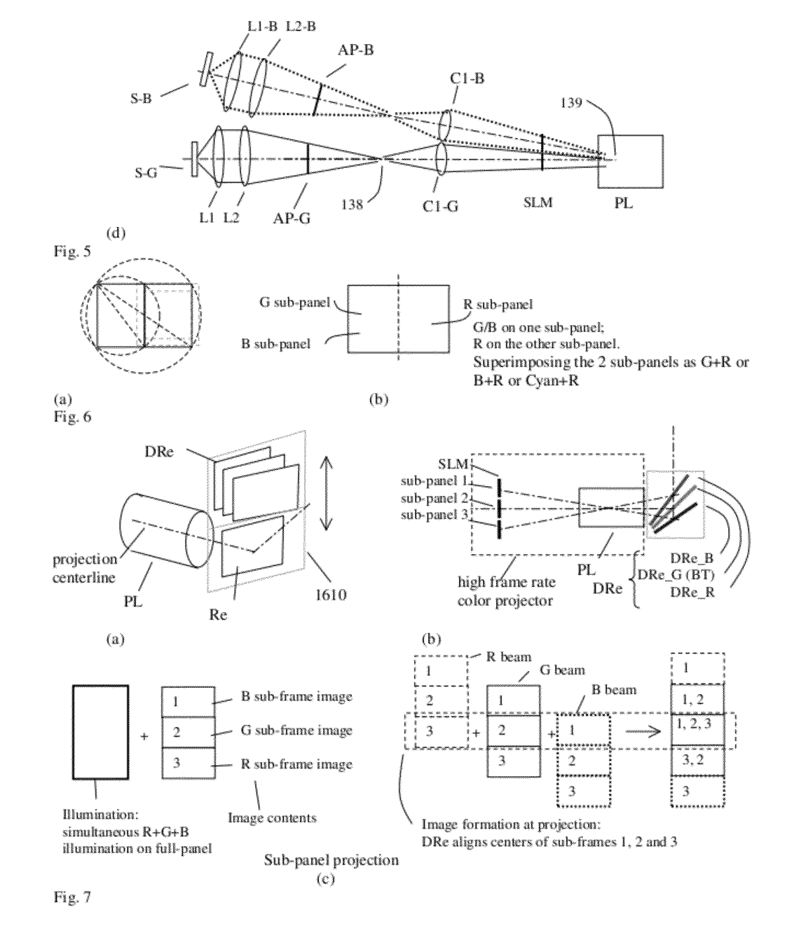

FIGS. 5(a) and (d) illustrates examples of LED arrangement when Kohler illumination is used.

FIG. 5(a) combines the light of 3 LED sources (S-R, S-G, S-B) by using 3 collecting lens L1 and dichroic reflectors. The combined unit 580 is a white light source, which can replace the lamp and L1 of FIG. 9(a).

FIG. 5(d) uses separated optics for different primary colors and contains no dichroic reflectors. (For simplicity, only rays of two colors are shown in these depictions, all in unfolded layout.) Each path of different primary color uses only one lens C1 to project aperture AP image onto the SLM. C1 also projects the image of the light source 138 to the projection lens, by using a different set of conjugates (138 and 129).

In design FIG. 5(d), lens C1-B and C1-G must be placed closely together. When the size of SLM is small, the width of these lenses must be limited. But the height of the lenses may need to be larger than the width in order to match the height of the sub-panels and to capture enough illumination. To resolve this problem, truncated lenses can be used. FIG. 5(f) illustrates 3 truncated lenses (LT-R, LT-G and LT-B) closely placed together to satisfy the need of different width and height.

The use of lasers as light sources for Pattern Illumination is described later.

### 1.3.1 The use of 2 Sub-Panels

In general, sub-panel illumination and projection use 3 sub-panels for 3 primary colors. In some cases, using only 2 sub-panels can have certain advantages. For example, the 0.17″ HVGA DMD of Texas Instruments has 480×320 pixels. If the DMD is divided into 3 sub-panels, then each sub-panel has 160×320 pixels, which could be too small. For example, Nintendo DS has 192×256 pixels and 3DS has 240×400. Further, because the DMD is already very small (3.63×2.42 mm active area), small sub-panels presents additional challenges to illumination optics. If the 0.17″ HVGA DMD is divided into 2 sub-panels (FIG. 6(a)), then each sub-panel can have the QVGA format. The aspect ratio (4:3) is closer to square. The size of sub-panel makes illumination easier. It is also possible to project a square LED source over a sub-panel.

FIG. 6(b) illustrates one example of 3 illumination patterns (R, G and B) illuminating 2 sub-panels. One of the 3 primary colors illuminates one sub-panel and the rest 2 primary colors illuminate the other sub-panel (simultaneously or selectively). For displaying V3D images, this arrangement has less color capability than using 3 sub-panels. However, it is quite enough for displaying computer generated V3D images, such as gaming images. For displaying 2D images, this arrangement can still provide full-color capacity at QVGA resolution.

### 1.4 Convertible Projection System and Method

In order for a projector system to operate in multiple modes, the optical system needs to convert between sub-panel projection and full-panel projection.

### 1.4.1 Regardless of Light Source Type or Illumination Type, Opto-Mechanical Conversion

(The 1st Design Example)

FIG. 7(a) illustrates a convertible unit including 2 sets of reflectors in front of the projection lens. One set contains R/G/B dichroic reflectors (DRe) and the other set contains a single plain reflector (Re). The two sets of reflectors are mounted on a sliding plane 1610. When the sliding plane is pushed up, the plain reflector reflects the projection beam. This is for full-panel projection. In this configuration, the illumination is sequential color over the full-panel of the image source (SLM). Full-panel 2D images can be projected.

When the sliding plane is pushed down, the set of dichroic reflectors reflect projection beam. This is for sub-panel projection. FIG. 7(b) illustrates a top view of this configuration. FIG. 7(c) illustrates illumination, SLM image contents and image formation at projection. Instead of sequential colors, the full-panel of SLM is illuminated with R+G+B lights (or a white light) simultaneously. However, the SLM is still divided into 3 sub-panels. Each sub-panel displays the contents of R, G and B sub-frames respectively. At projection, the dichroic reflectors align the centers of each sub-frame of different colors. As a result, the images of sub-panels 3, 2 and 1 superimpose to become one color frame. The unwanted part of the projection beam can be blocked by using an aperture stop.

In this design, if the R, G and B light sources are separated (such as using LEDs), then the layout of illumination optics do not need to change. Only the timing of illumination changes (sequential or simultaneous). If the light source is a single white light and a sequential color device (such as a color wheel) is used in full-panel projection, then the color wheel needs to be pushed aside in the case of sub-panel projection.

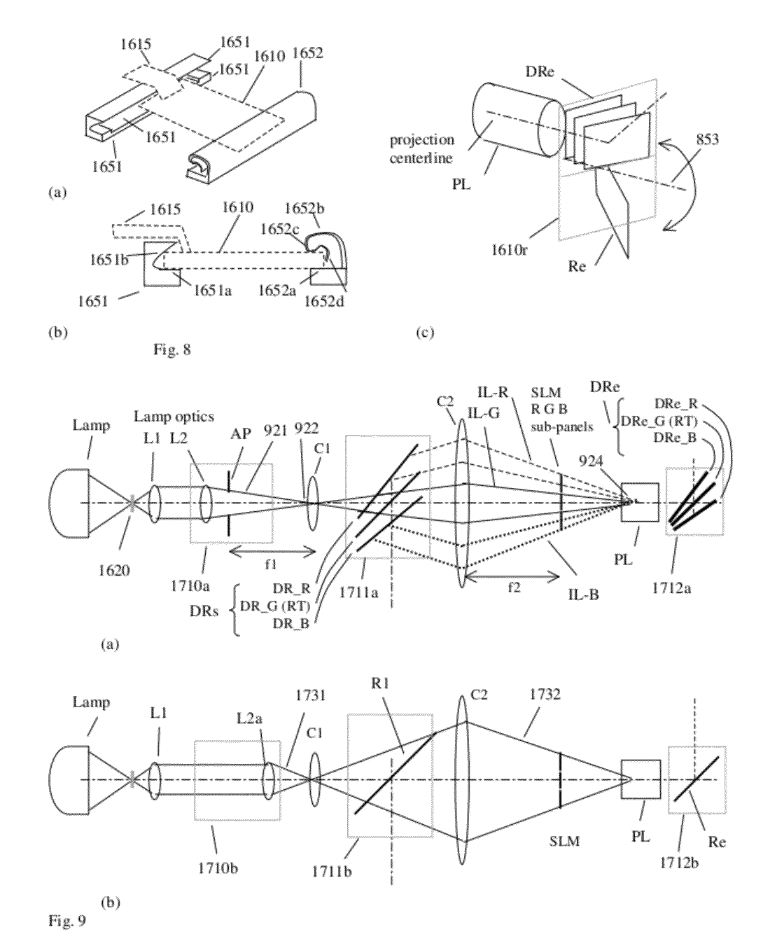

The sliding plane 1610 slides between two positions. FIGS. 8(a) and (b) depict an example of a simple mechanism for this purpose. The sliding plane 1610 has a handle (or manual slide bar) 1615. Pushing the handle makes the sliding plane 1610 to slide on two rails 1651 and 2652. The two rails can be an integral part of the housing if it is manufactured by molding. The step structures 1651c at the two ends of rail 1651 decide the two positions of the sliding plane. A spring structure 1652b exerts a downward force at 1652c to push the sliding plane against the rail surface 1652a and a lateral force at 1652d to push the sliding plane toward rail 1651. A curved upper contact surface 1651b keeps the sliding plane in contact with the sliding surface 1651a. In this way, the sliding plane is in contact with the parallel sliding surfaces of the rails at all time to keep its orientation invariant.

In general, a convertible unit is an optical mechanical mechanism that can be moved between two positions. FIG. 8(c) illustrates another example. The plane 1610r carrying the 2 sets of reflectors can rotate about an axis 853. The rotation switches the convertible unit between two positions.

One shortcoming of the system of FIG. 7 is that only ⅓ of the light are used in sub-panel projection, because the light of each primary color illuminates the full-panel. For better illumination efficiency, conversion between sub-panel illumination and full-panel illumination is needed.

### 1.4.2 Kohler Illumination, Opto-Mechanical Conversion

(The 2nd Design Example)

FIGS. 9(a) and (b) illustrate the 2nd design. The light source is a lamp. The illumination is Kohler. FIG. 9(a) illustrated sub-panel illumination/projection, which has been described previously. FIG. 9(b) illustrates the system in full-panel projection.

In FIG. 9(b), a condenser lens L2a (1710b) replaces condenser lens L2 and aperture plate AP (1710a) of FIG. 9(a). Lens L2a has a shorter focal length and is placed closer to C1 so that the illumination (1731, 1732) covers the full panel of SLM. A single reflector R1 (1711b) replaces the dichroic reflectors DRs (1711a). A single reflector (1712b) replaces the exit dichroic reflector set (1712a).

FIG. 9(c) illustrates the system in perspective view (using a DMD as the SLM). The system includes 3 convertible units, 1710, 1711 and 1712. Each unit can be a sliding plane of FIG. 8. These sliding planes enable the conversion between the layouts of FIG. 9(a) and of FIG. 9(b). The sliding planes of units 1710 and 1711 can be coupled together, so that one action can convert these two units.

If only two sub-panels are defined on the SLM, the design will be similar, except that only two dichroic reflectors are needed at DRs and DRe.

1.4.3 Abbe illumination, Opto-Mechanical Conversion

(The 3rd Design Example)

FIGS. 10(a) and (b) illustrate the 3rd design. The light source is a lamp. The illumination is Abbe. FIG. 10(a) illustrates a layout of sub-panel illumination/projection (shown as unfolded). FIG. 10(b) illustrates the system converted into full-panel projection. Similar to FIG. 9, the design has 3 convertible units (1610a/1610b, 1611a/1611b and 1612a/1612b). Units 1611a/1611b and 1612a/1612b are similar to units 1711a/1711b and 1712a/1712b of FIG. 9. In the conversion from 1610a to 1610b, a condenser lens L2a (1610b) replaces condenser lens L2 and aperture plate AP (1610a) of FIG. 10(a). Lens L2a has a longer focal length and is placed farther from C1, so that it projects a larger image 1621 of the focal spot of the lamp at the focal plane of C1. Therefore, this larger light source image can cover the full panel of SLM at 1622, achieving Abbe illumination.

### 1.4.4 LED as Light Source, Kohler Illumination, Opto-Mechanical Conversion

(The 4th Design Example)

In this case, the preferred illumination solution is to use the layout of FIG. 9, but replace the lamp and the first collecting lens L1 by the 3-LED source of FIG. 5(a).

### 1.4.5 LED as Light Source, Abbe Illumination, Opto-Mechanical Conversion

### 1.4.5.1 (Separated LED Sources, Dichroic Reflectors Merging Colors)

(The 5th Design Example)

FIG. 11(a)-11(b) illustrates this design in perspective view. S-R, S-G and S-B represent 3 LED sources. LED size is generally small compared to the diameters of collecting lens (C1 or C1a) and other optical components. The layout of light collecting and combining is similar to FIG. 5(a), but with different alignment details. A 2-condenser lens structure (C1/C1a and C2) projects the source image onto the SLM. Dichroic reflectors are placed between C1 and C2 to combine the 3 colors. There are 2 sets of light collecting lens (3 C1 and 3 C1a) mounted on a sliding plane 810. Sliding the plane between two positions selects C1 or C1a as the collecting lens under the LED sources. In order to illustrate optical alignment clearly, the layout from the dichroic reflectors to the SLM is simplified and some components are omitted.

FIG. 11(a) is the case of sub-panel illumination. 3 lenses C1 are used as collecting lenses. The focal lengths of lenses C and C2 (f1 and f2 respectively) have the following relation:

f2/f1=Ma=magnification=size of sub-panel/size of LED source.

Thereby, the image of one LED source can cover one sub-panel. In addition, the position of LED source S-R is offset to the left relative to the centerline 873-R. Therefore, the red illumination pattern IP-R is projected to the opposite side of the centerline 873. In similar way, blue illumination pattern IP_B is offset to the other side. Source S-G is positioned on the axis of C1 (873-G)(centerline 873). As a result, the R, G, B illumination patterns can be aligned to the corresponding sub-panels.

FIG. 11(b) illustrates the case of full-panel illumination. 3 lenses C1a replace C1. In this case, the focal length of C1a (f1a) is decided from the following relation:

f2/f1a=Mb=size of full-panel/size of LED source.

Thereby, the image of one LED source can cover the full-panel. The axes of C1a lens (875-R, 875-G, 875-B) are aligned to the corresponding LED sources (S-R, S-G, S-B). That is, the axes (875-R and 875-B) of lens C1a for R and B LEDs are offset relative to system centerline 873. This way, the illumination patterns of 3 colors are all projected to the center of the SLM. Homogenizing optics, such fly's eye lens, can be added into the path, usually before C2. Also, lens C1 may contain more than one lens in order to maximize light collecting efficiency. In such cases, the focal plane location after C2 or before C1 should be corrected accordingly. These corrections are known to optical system designers and can be simulated using a ray tracing software program.

(The 6th Design Example)

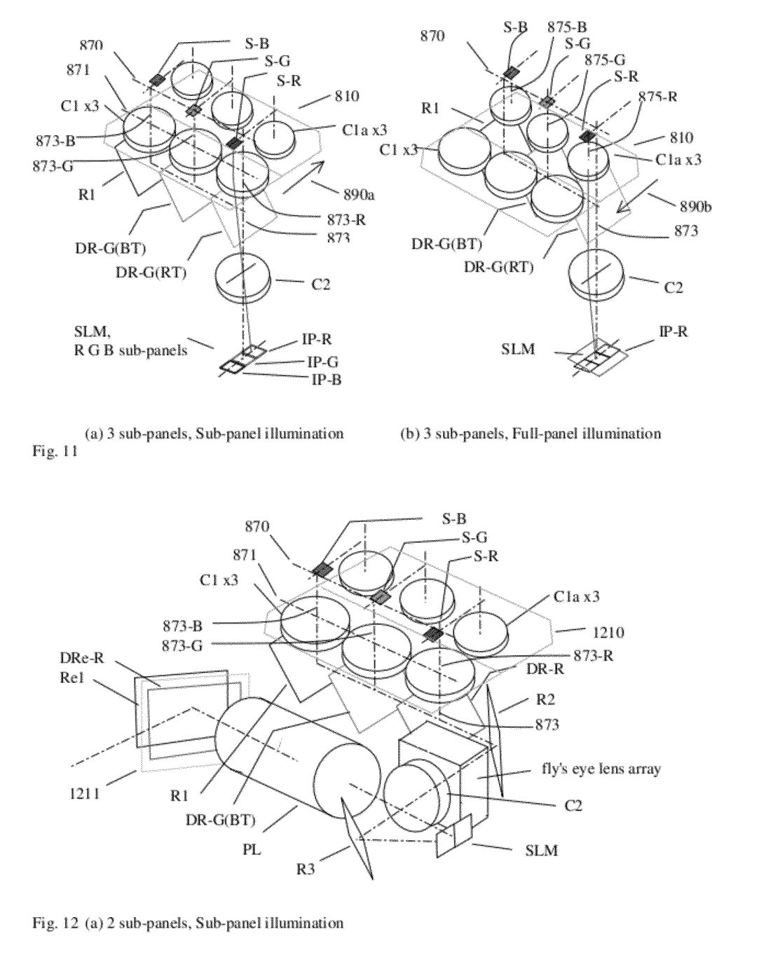

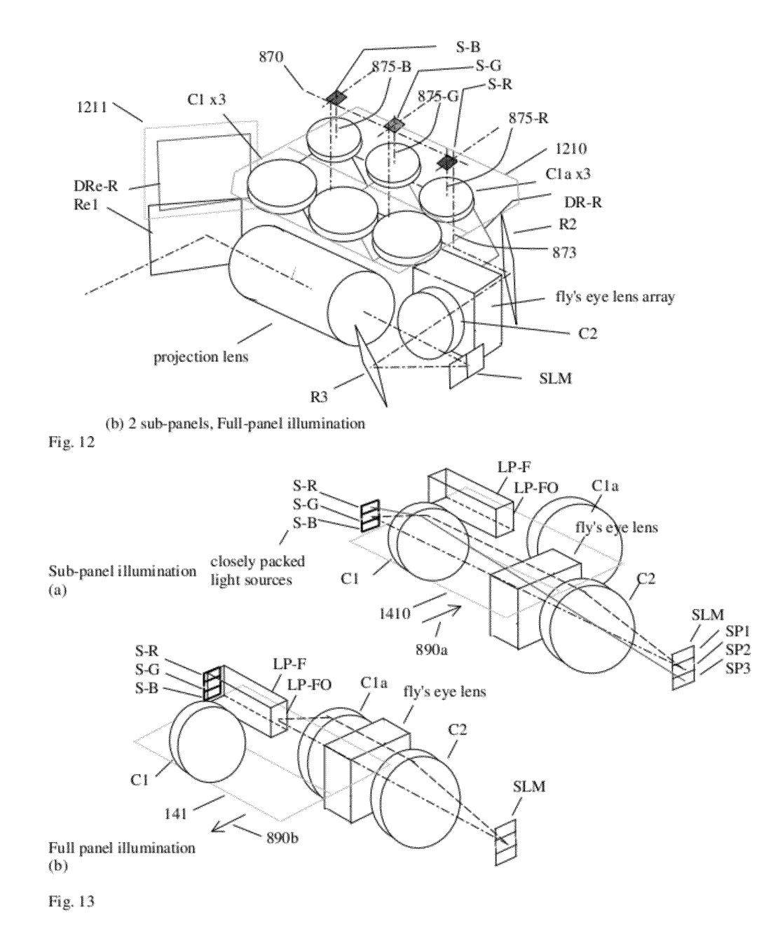

FIG. 12 illustrates a design for 2 sub-panel case, in perspective view of a compact layout. The design of illumination is basically similar to FIG. 11, except for different alignments and offsets. In sub-panel illumination, S-G and S-B have the same offset so that G and B illumination patterns are projected to the same sub-panel.

The system has two sliding planes. Sliding plane 1210 carries 6 condenser lenses (C1×3 and C1a×3). Sliding plane 1211 carries one red-dichroic reflector.

### 1.4.5.2 (Closely Packed Light Sources, Light Pipe Merging Colors)

(The 7th Design Example)

See FIG. 13(a)-(b). This design uses closely packed R G B light sources (S-R, S-G and S-B) and a light pipe, instead of dichroic reflectors, to merge colors into white light for full-panel illumination.

In sub-panel illumination (FIG. 13(a)), because the sources (S-R, S-G and S-B) are closely packed, a 2-condenser-lens (C1 and C2) system can project the source images directly upon the SLM. Each sub-panel is illuminated by a source of different primary color. For example, S-G is projected onto sub-panel SP2 and S-R is projected onto SP3.

In full-panel illumination (FIG. 13(b)), light from the light sources is first collected by a (color mixing) light pipe LP-F. The light pipe homogenizes and distributes the light to the output end (LP-FO). In other words, if only S-R is switched on, then the output end of the light pipe emits uniform red light. If only S-G is turned on, the output end emits uniform green light. If more than one source is turned on, then the colors mix. The output end of the light pipe is used as the new light source and is projected upon the SLM to cover the full-panel. As a result, sequential color illumination can be made upon the full-panel.

The sliding plane 1410 for layout conversion needs only to carry C1 (for sub-panels) and C1a and LP-F (for full panel). In general, the light sources are placed at lens C1's focal plane. LP-FO is placed at lens C1a's focal plane.

(The 8th Design Example)

FIG. 14 illustrates an example based on the same design principles, but for 2 sub-panel case. The 2 sub-panels configuration of FIG. 6(b) is used as an example.

Separated LED devices (LED-R, LED-G and LED-B) and a 1st-stage light pipe system (LP-R, LP-G and LP-B) is used to generate R, G and B light sources (S-R, S-G and S-B). The light sources (i.e. output ends of the 1st-stage light pipes) are arranged inside a rectangular plane (1590) as shown in FIG. 14(a). S-G and S-B are placed side-by-side in the lower portion of the plane, and S-G in the upper portion.

In sub-panel illumination, a 2nd-stage light pipe (LP-S) comprises two separate but closely placed light pipes (LP-S1 and LP-S2). LP-S1 corresponds to S-R (red). LP-S2 corresponds to S-G and S-B (green & blue). A 2 condenser lenses (C1 and C2) system project the new source images (LP-S1O and LP-S2O) directly upon the SLM. LP-S1O (from S-R) is projected onto sub-panel SP2 and LP-S2O (from S-G/S-B) onto SP1.

In full-panel illumination, the design is basically similar to FIG. 13(b). As shown in FIG. 14(b), if LP-S and LP-F have the same length, then the same C1 can be used. The only parts need to be on the sliding plane 1510 are the two 2nd stage light pipes.

By using light pipes, the 7th and the 8th design examples have very simple configurations. They use only a few parts that can be made by molding.

### 1.4.6 Generalized Description of Opto-Mechanical Conversion of Illumination Modes

The illumination system can be converted between two optical layouts, one optical layout for sub-panel illumination and one for full-panel illumination. The conversion between the two layouts is by mechanically moving at least one optical sub-assembly between two positions.

When an aperture plate is used to generate illumination patterns, the sub-panel illumination layout uses a set of dichroic reflectors to guide images of the aperture plate onto different sub-panels. In full-panel illumination layout, the aperture plate is removed and part of the collecting lens of the lamp is replaced. In the case of Kohler (or near Kohler) illumination, the new collecting lens has a shorter focal length so that the beam covers the full-panel. In the case of Abbe illumination, the new collecting lens gives a larger source spot size so that the spot size covers the full-panel.

When LED sources are used as illumination patterns, the image of LED sources are projected to cover different sub-panels (in the sub-panel illumination layout) or to cover the full-panel of the SLM (in the full-panel illumination layout). Dichroic reflectors or light pipes can be used for mixing colors.

### 1.4.7 Solid-State Conversion, by Flexible Sub-Panel Illumination

The basic concept can be described as follows:

(a) One set of closely packed multiple LED sources is used for each primary color. 2 LED sources if the SLM is divided into 2 sub-panels. 3 LED sources if the SLM is divided into 3 sub-panels.

(b) In the illumination of each primary color, each LED source in a set corresponds to one different sub-panel. That is, each sub-panel can be illuminated by only one different LED source in the set.

(c) The illuminations from LED sources of different primary colors are merged onto the SLM. As a result, any sub-panel can be illuminated by any one of the 3 primary colors. Therefore, this approach can be called “Flexible Sub-panel Illumination”. In sub-panel illumination, only one LED source in a set is turned on and illuminates only one sub-panel. Each sub-panel is illuminated by a different primary color by one LED chip from a different set. In full-panel mode, all LED sources in each set are turned on to illuminate all sub-panels. In this way, the conversion is purely solid-state switching. Therefore, the conversion can be very fast. This also allows almost simultaneous display of 2D images on a 2nd screen side by side with any one of the 3 display modes.

### 1.4.7.1 (Separated LED Sources, Dichroic Reflectors Merging Colors)

(The 9th Design Example)

FIG. 15(a) illustrates the idea with a 3-sub-panel example. This is similar to FIG. 11(a), except that each primary color has 3 closely packed LED sources and only 3 lenses C1 are needed. FIG. 15(b) explains the operations in sub-panel mode and in full-panel mode.

(The 10th Design Example)

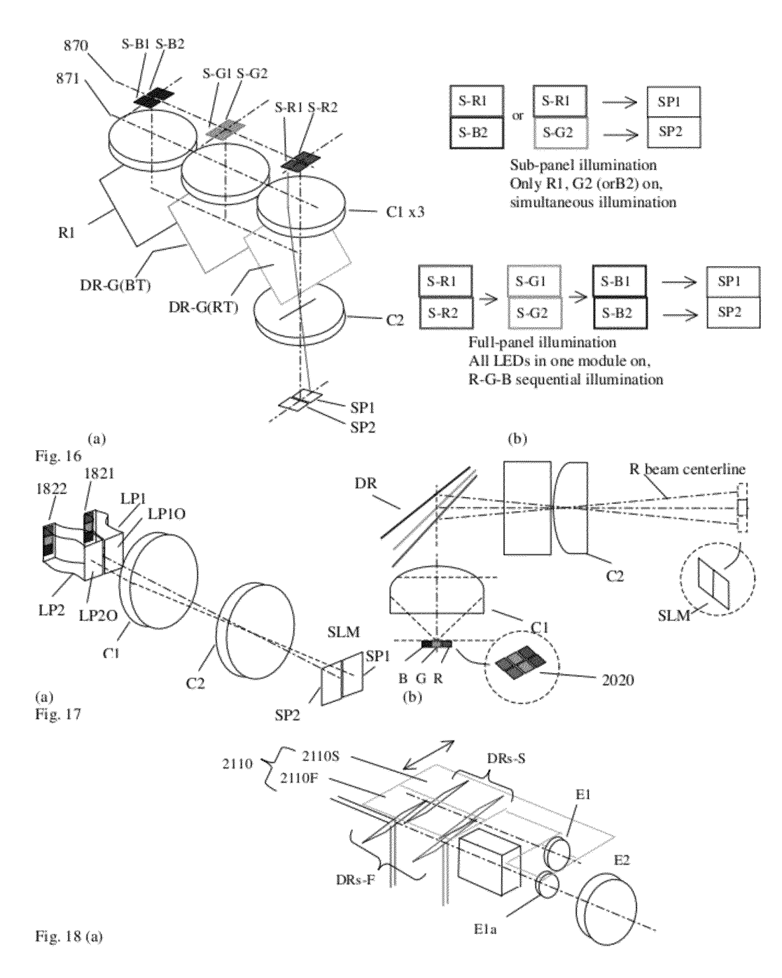

FIG. 16(a) illustrates the basic optical layout with a 2 sub-panel example. LED sources of each primary color are projected onto the SLM's corresponding sub-panels. For example, the image of S-R1 covers sub-panel SP1, and S-R2 covers SP2. As a result, by selectively turning on or turning off different LED sources, different illumination scenarios of FIG. 16(b) can be created.

### 1.4.7.2 (Closely Packed Light Sources, Light Pipe Merging Colors)

(The 11th Design Example)

FIG. 17(a) illustrates a system for 2 sub-panels cases. The system has two separate LED modules 1821, 1822. Each module has 3 closely packed LED devices of different primary colors (red, green and blue). A light pipe system (LP1 and LP2) guides the light from the two LED modules to two output ends (LP1O and LP2O) that are placed side-by-side and closely. The light pipes homogenize and mix light. The 2 condenser-lenses (C1 and C2) project the image of LP1O onto sub-panel SP2, and LP2O onto sub-panel SP1.

### 1.4.7.3 (Closely Packed LEDs, Dichroic Reflectors Merging Colors)

(The 12th Design Example)

FIG. 17(b) illustrates a system for 2 sub-panel cases. It uses one module of closely packed 2×3 LED sources (2R, 2G and 2B) 2020. A single C1 lens and a single C2 lens form a 2-condenser lens configuration. A set of dichroic reflectors (DR) merges the images of the sources of 3 primary colors onto the SLM. Conceptually, this design is a compact form of FIG. 16(a). It requires only one C1 lens, instead of 3. However, the trade-off is the source size (2×3 LEDs) is 3 times larger than the 2 LEDs used with each C1 lens in FIG. 16(a).

### 1.4.8 Laser as Light Sources

(The 13th Design Example)

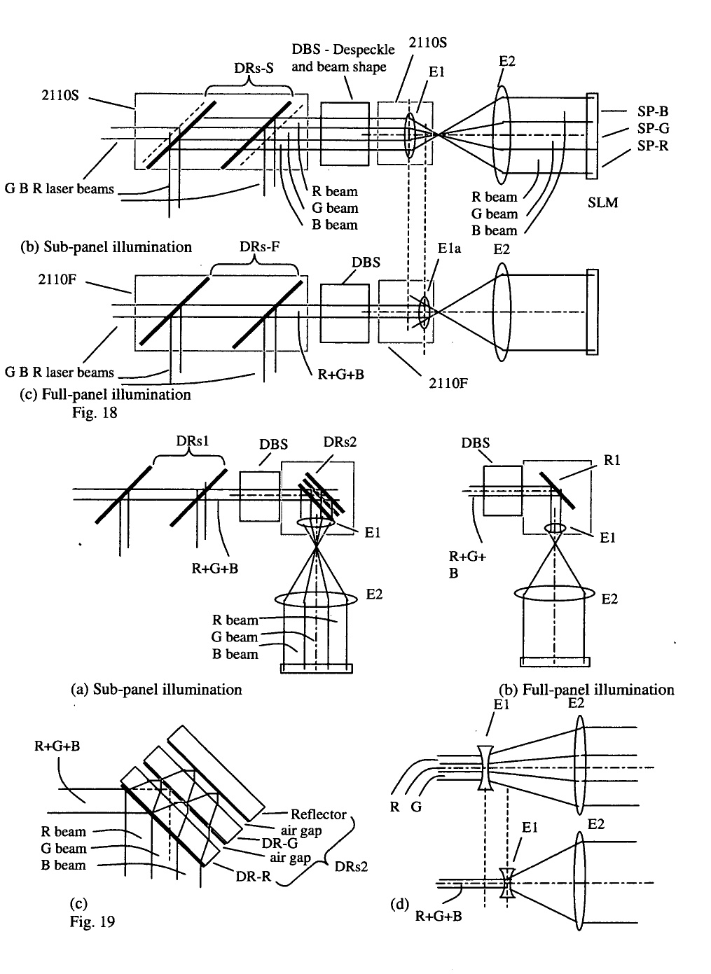

In full-panel illumination (FIG. 18(c)), a set of dichroic reflectors combine R, G and B beams into a white beam. A beam expander (E1a and E2) expands the beam size to cover the full-panel of the SLM.

In sub-panel illumination (FIG. 18(b)), the positions of dichroic reflectors are changed slightly to intersect the R, G and B beams at slightly different heights. Therefore, the 3 beams are aligned as a closely packed beam array. Lens E1 replaces E1a. Lens E1 and E2 expand each beam to a size to cover one corresponding sub-panel.

The conversion of DRs and E1 use an integrated sliding plane 2110 and can be performed in one action. (FIG. 18(a))

(The 14th Design Example)

See FIG. 19(a)-(b). A set of dichroic reflectors (DRs1) combines R, G and B beams into one white beam. In sub-panel illumination (FIG. 19(a)), the combined white beam is split up into 3 closely packed beams by a 2nd set of dichroic reflectors (DRs2) after DBS. A beam expander (lenses E1 and E2) expands each beam to a size to cover one corresponding sub-panel. FIG. 19(c) illustrates the configuration of the dichroic reflector set and reflections and transmissions of rays through the set.

In full-panel illumination (FIG. 19(b)), a single reflector R1 and a lens E1a replace DRs2/E1. E1a has a shorter focal length and is placed closer to E2. As a result, the magnification of the expander is increased to cover the full-panel.

A sliding plane similar to that of FIG. 18(a) can be used for switching.

The above examples use Keplerian expander, which uses two positive lenses. FIG. 19(d) shows that Galilean expander, which uses one negative lens and one positive lens, can also be used in those design examples.

### Part 2: Auto-Stereoscopic 3D Display by Position-Changing Parallax Barriers

### 2.1 Background and Issues to Resolve

Existing as3D approaches use either directional blocking (parallax barriers or lenticular lens) or directional illumination (directional back lighting of LCD or beam converging optics (e.g. Fresnel lens) as projection screen). These approaches are difficult to apply to this invention.

Because a translucent and diffusive (Lambertian) screen is preferred for V3D mode, a Fresnel lens or a lenticular lens can not be used as the screen. In as3D LCD displays, parallax barriers mask can be placed at the back of a LCD panel for directional illumination. But this can not be applied to a diffusive rear projection screen. Parallax barriers placed over the screen can block significant area of the screen and can not provide diffusive image for V3D mode.

### 2.2 Summary of the Solution

The solution is to use a “Position-Changing parallax barriers” panel in front of the screen and use sequential frames to display images.

A “Position-Changing” parallax barrier panel is capable of switching between a transparent state and an opaque state in selective areas of the panel. Therefore, the positions of array of viewing apertures and barriers can change on the panel. The parallax barrier panel presents a set of barrier-states in sequence repeatedly. In each barrier-state, the viewing apertures cover a different area of the panel. But in combination, all viewing apertures presented in all barrier-states cover full area of the panel.

A set of field frames is displayed on the screen in sequence corresponding to the sequence of the barrier-states presented by the parallax barrier panel. When viewed through the parallax barrier panel by left eye, these field frames appear as a full-frame left eye image that is visible only to left eye. When viewed by right eye, these field frames appear as a full-frame right eye image that is visible only to right eye. The left eye image and the right eye image form an autostereoscopic image.

This approach has the following unique features:

The barriers can be narrow or wide.

When wide barriers are used, the requirement on alignment precision is less strict than that of existing parallax barrier techniques.

When barriers change positions at a frequency above the critical fusion frequency of vision, they become invisible and do not block the view.

This approach can be used with all kinds of displays, including rear projection on a simple diffusive screen. It allows a wide range of distance between the barrier panel and the image display (from under 1 mm to several cm). Therefore, the barrier panel does not need to be closely attached to the screen. It is suitable for the multi-mode feature of this invention.

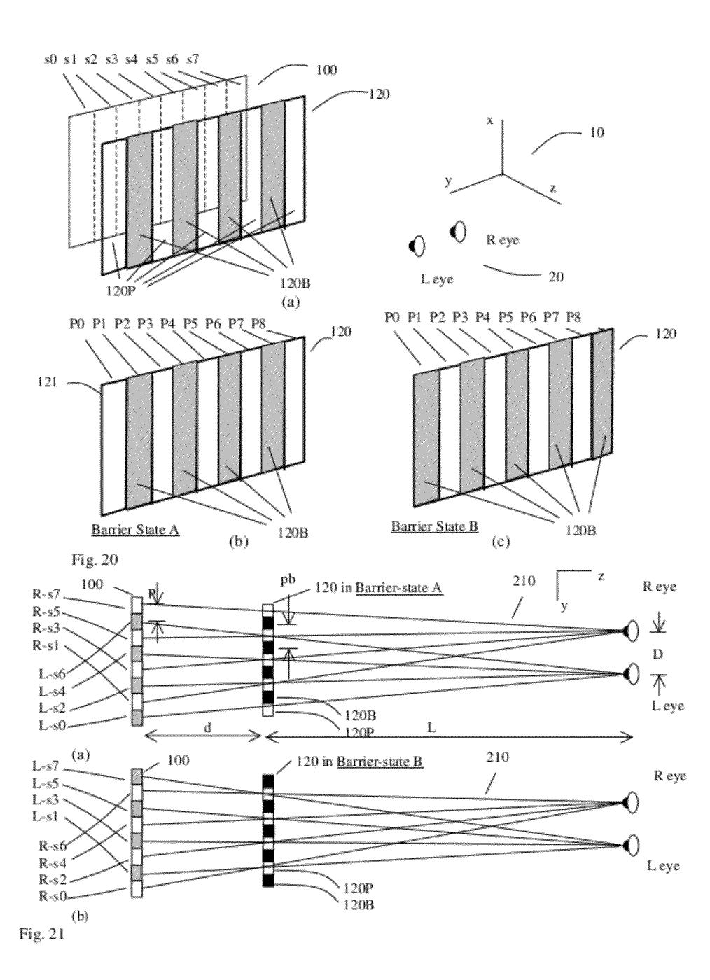

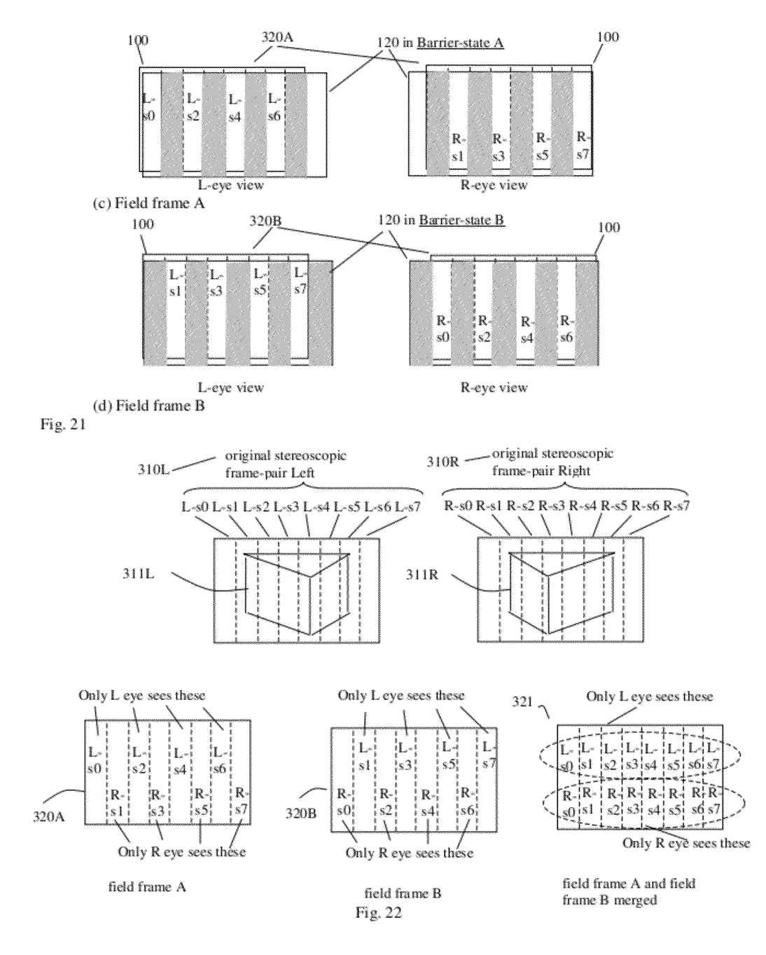

FIG. 20(a) illustrates the components and the general layout of the system in perspective view. The viewer 20 observes the images on the 2D display 100 through the barrier panel 120. The barrier panel contains opaque parts (the barriers) 120B and transparent parts (the viewing apertures) 120P.

The barrier panel can change (or switch)(or move) the positions of the opaque parts and the transparent parts. As illustrated in FIG. 20(b), the positions are indicated as P0 to P8 relative to the frame of the panel 121. The barriers (120B) are at odd number positions (P1, P3, P5, and P7). This is called “Barrier-State A” for convenience. In FIG. 20(c), the barriers are switched to even number positions (P0, P2, P4, P6, and P8). This is called “Barrier-State B” for convenience.

FIG. 21 illustrates the principle of operation.

FIG. 21(a) shows a top view of the system layout with the barrier panel 120 in “Barrier-state A”. The 2D display 100 is divided into vertically-oriented image stripes s0-s7, as depicted in FIG. 20(a). The line of sight 210 shows that the left eye sees only the even number image stripes (s0, s2, s4, s6)(labeled as L-s0, L-s2, L-s4 and L-s6) and the right eye sees only the odd number image stripes (R-s1, R-s3, R-s5 and R-s7). FIG. 21(c) illustrates the views of the left eye and of the right eye corresponding to FIG. 21(a).

When the barrier panel switches to “Barrier-state B”, the left eye sees only the odd number stripes and the right eye sees only the even number stripes, as illustrated in FIG. 21(b) and FIG. 21(d).

One image frame of an as3D image includes two successive “field frames”. The first field frame (field frame A) corresponds to FIGS. 21(a) and 21(c). The second field frame (field frame B) corresponds to FIGS. 21(b) and 21(d). The two field frames are displayed successively in a frequency higher than the critical fusion frequency (>=18 Hz typically). The barrier panel also switches between state A and state B in synchronization with the two field frames. As a result, the two field frames appear as one image to the eyes of the viewer. To the left eye, the even number stripes of field frame A and the odd number stripes of field frame B merge into a full frame of left eye view. To the right eye, the odd number stripes of field frame A and the even number stripes of field frame B merge into a full frame of right eye-view. Therefore, the viewer sees a full frame of as3D image.

FIG. 22 further illustrates the arrangement of image stripes in the field frames. The original stereoscopic frame pair includes a left-eye-view frame 310L and a right-eye-view frame 310R. 311L(R) is an example object shown in its left (right) eye view. The labels of image stripes are the same as those of FIG. 20 and FIG. 21.

### 2.3 Position-Changing Barriers

There are several ways to implement a position changing parallax barrier panel.

### 2.3.1 Liquid Crystal Shutters

An array of liquid crystal shutters can be used as a set of position-changing parallax barriers.

Different types of liquid crystal shutters can be used, including the following:

TN (Twist Nematic) cell: Off-state is similar to a half wave retarder (transparent when sandwiched between 2 crossed polarizers)

Pi-cell: Off-state (rest state) is non-transparent (when sandwiched between 2 crossed polarizers). A voltage switches the cell into a “Pi-state” (transparent).

FLC (ferroelectric liquid crystal): Function is similar to TN cell but is bistable.

PDLC (polymer dispersed liquid crystal): Off-state is non-transparent.

Except PDLC, other 3 types of shutter require the use of polarizers. TN LC cells are the most common and are the cheapest. In general, a TN LC cell can be switched at 90-100 Hz. The TN cell is used as an example to illustrate the principle of this invention.

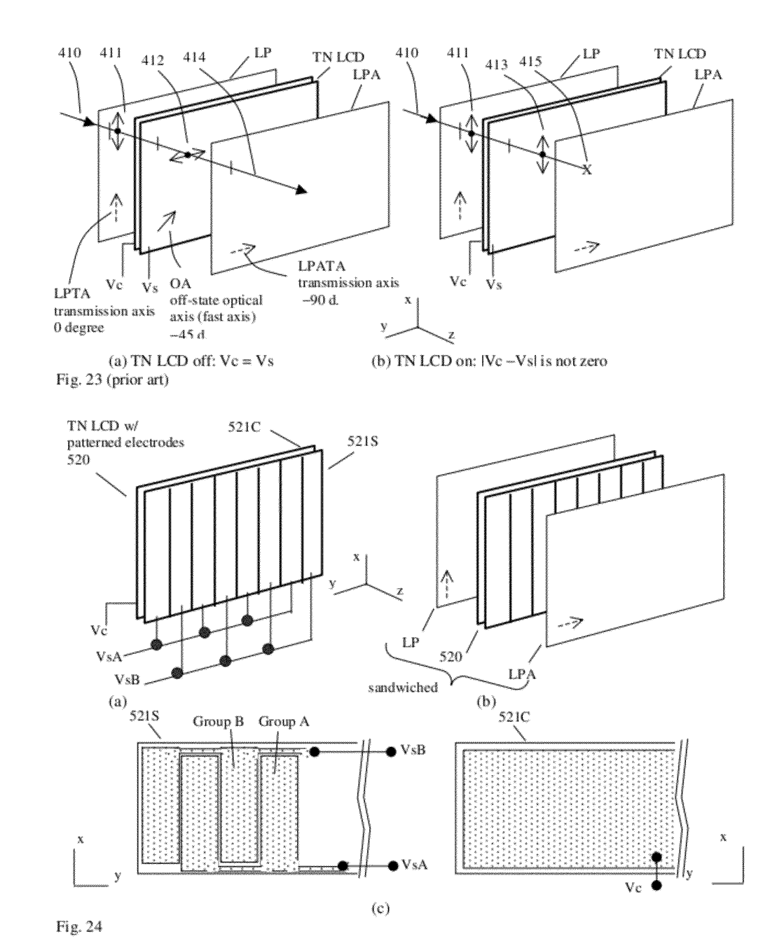

FIG. 23 illustrates the operating principle of a TN LC shutter. The cell is sandwiched between two polarizers LP and LPA. The transmission axes of the two polarizers are set at 0 degree (LPTA) and −90 degree (LPTATA). An incident light 410 passes the polarizer LP and becomes polarized with the transmission axis parallel to x-axis, 411.

In off-state (no voltage applied)(FIG. 23(a)), the TN cell behaves like a half wave plate. The optical axis OA of the TN cell is −45 degree. As a result, the TN cell rotates the polarization axis of the light at 411 by 90 degree. Therefore, the light can pass the analyzer LPA. The shutter is opened.

In FIG. 23(b), a voltage (|Vc-Vs|) is applied to the two electrodes (common and segment). The resulted electric field disrupts the twist (helical) structure of the liquid crystals. Therefore, light passes the cell without changing its polarization state, 413, and is blocked by the analyzer LPA. The shutter is closed.

### EXAMPLE 1

### (Barrier Patterns are on LC Cell)(FIG. 24)

One glass plate 521C of the cell has a single electrode (i.e. a transparent ITO (Indium Tin Oxide) coating)(called “common electrode” in the LC industry). The other glass plate 521S has two groups of “segment electrodes”. FIG. 24(c) illustrates the idea. Voltage VsA and VsB are applied to Group A and B stripe electrodes respectively. By controlling the values of VsA and VsB relative to the common electrode (Vc), the areas corresponding to the two groups can be switched independently. By alternately switching on the two groups of TN cell arrays, Barrier-state A (FIG. 21(c)) and Barrier-state B (FIG. 21(d)) can be generated. This panel works in both directions.

### EXAMPLE 2

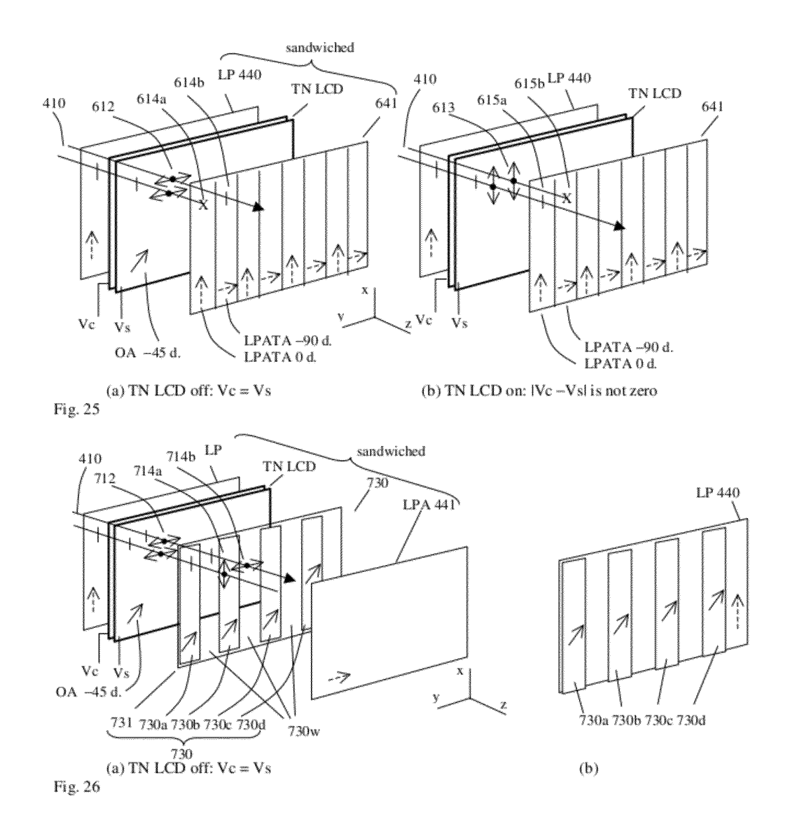

### (Barrier Patterns are on Polarizer)(FIG. 25)

This example is similar to FIG. 23 except that the analyzer 641 is a patterned analyzer. The patterned analyzer has alternating stripes with transmission axis arranged in two perpendicular directions, thereby forming two groups of shutter stripes. The patterned analyzer can be made by assembling individual polarizer stripes into a mosaic. This panel also works in two directions.

### EXAMPLE 3

### (Barrier Patterns are on Passive Retarder)(FIG. 26)

FIG. 26(a) is basically adding an array half wave retarders 730 to FIG. 23(a). The retarder array can be constructed by attaching retarder stripes (730a, 730b, 730c and 730d) to a glass plate 731. The optical axes of the retarder array is aligned to −45 degree (45 degree relative to the transmission axis of polarizer 440). The retarder will rotate the transmission axis of the light out of the TN LCD by 90 degree. Between every two adjacent retarder stripes, there is an open space 730w, which has no effect on polarization. As a result, the combined effect of the retarder array 730 and the analyzer LPA 441 to a linear polarized light is similar to the patterned analyzer LPA 641 of FIG. 25.

The retarder array can also be made as an integral plate with stripes of different thickness. A retarder array can also be attached to one of the polarizer, as shown in FIG. 26(b). The retarder array 730 can also be placed between the TN LCD and the polarizer 440.

### 2.3.2 Micro-Mechanical

Micro-mechanical shutters can also be used. Two types of “smart glass” can be used: (1) Micro-Blinds and (2) Suspended Particle devices. (Ref. http://en.wikipedia.org/wiki/Smart_glass, which is incorporated into this invention by reference.)

### 2.4 Parallax Barrier Panel for Viewing in 2 Orientations

It will be nice if a system can display as3D images in both orientations (horizontally or vertically) (i.e. in landscape view or in portrait view).

2.4.1 Method 1: LC Cell with Matrix Electrode Configuration

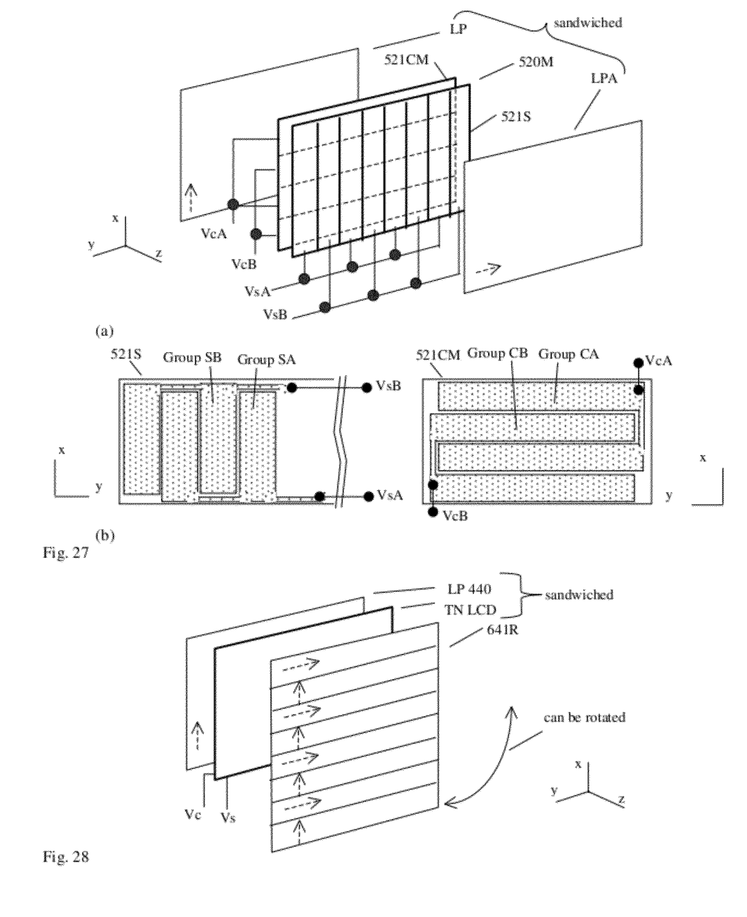

FIG. 27 illustrates a LC cell having a matrix electrode configuration. This is similar to FIG. 24, except that the pattern of the common electrodes on the other glass plate 521CM also has two groups of stripes (Group CA and Group CB), which are oriented in perpendicular direction relative to the segment electrodes (Group SA and SB). This matrix construction is similar to the traditional passive LCD's matrix electrode construction. These electrode groups are connected to voltage signals (VsA, VsB, VcA and VcB) respectively (FIG. 27(b)).

When the system is to be viewed horizontally, VcA and VcB are brought to a same voltage (say Vc) at all time. This works basically the same as the system of FIG. 24. When the system is to be viewed vertically, the roles of segment electrodes (Group SA/SB) and common electrodes (Group CA/CB) reverse. VsA and VsB are brought to a same voltage (say Vs) at all time. Thereby, the barrier panel has barriers stripes oriented in y-direction.

### 2.4.2 Method 2: Rotary Polarizer-Stripes

FIG. 28 is basically the same as FIG. 25, except that the analyzer 641R can be rotated. Therefore, the orientation of the barrier stripes can be changed by manually rotating the analyzer by 90 degree.

### 2.4.3 Method 3: Rotary Retarder-Stripes

Alternatively, a system similar to FIG. 26(a) can have a rotary retarder plate. The orientation of the barrier stripes can be changed by manually rotating the retarder plate by 90 degree.

### 2.4.4 Method 4: Barriers in Checker-Board Configuration

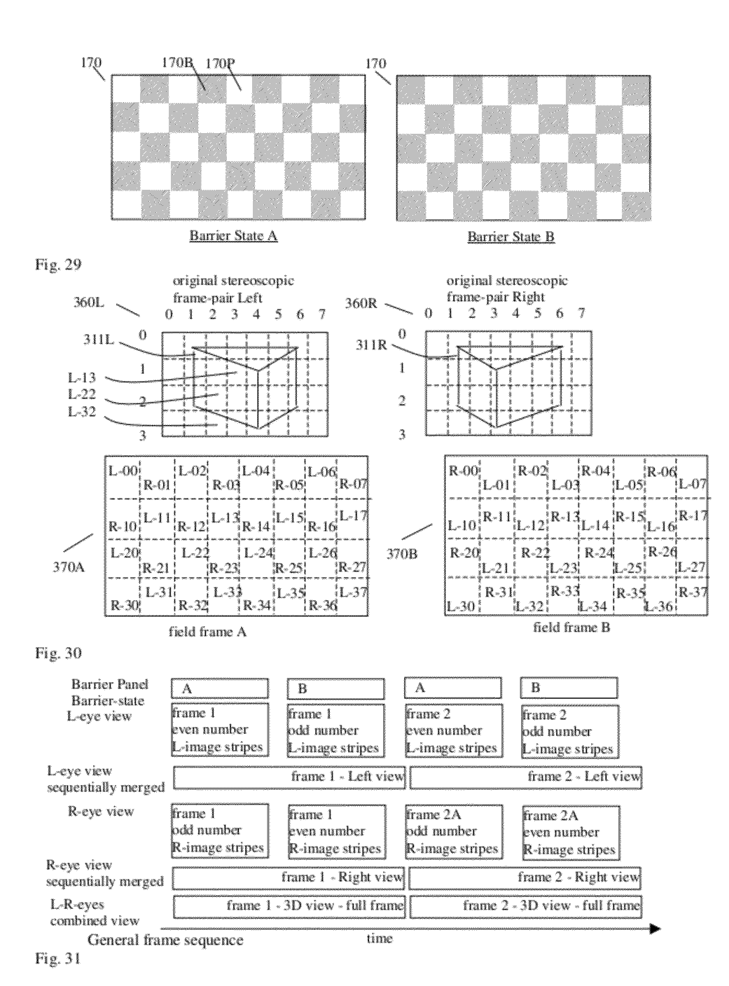

FIG. 29 illustrates a barrier panel 170 with a checker-board configuration that can be switched between two different states. 170B are opaque. 170P are transparent. Barrier-state B is basically a negative image of Barrier-state A.

The principle of viewing is the same as before, except that the contents displayed in the 2D display 100 is different. FIG. 30 illustrates the arrangement of image units in the field frames. The left and right frames of the original stereoscopic image pair are each divided into many squares units. (For example, L-13 represents the image unit at (row 1, column 3).) Image units from the left frame and from the right frame are also arranged in a checker-board configuration.

The LC shutters array in checker-board configuration can be constructed by patterning the electrode of the LC cell or the polarizer (or analyzer) into checker-board configuration.

The barrier units and image units can be rectangles as well.

2.5 Sequential Frame Image Arrangement when Pattern Projection is Applied

FIG. 31 shows a general frame sequence.

For DMD and FLCD (FLCOS), colors are generated by a field sequential technique using pulse width modulation. In these cases, “color field frames” of different duration and different primary colors are sequentially displayed (or projected). Therefore, it is important to distinguish these very short “color filed frames” from the “field frames” described in this invention.

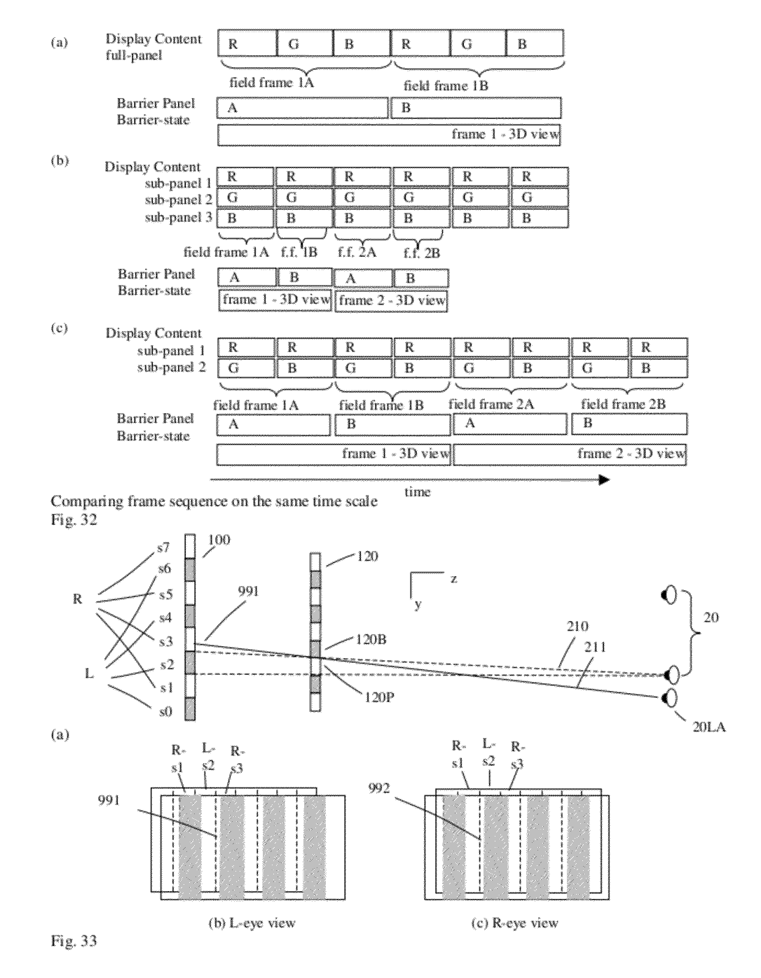

FIG. 32 illustrates frame sequences to be used when a high frame rate SLM (such as a DMD) is used, under different sub-panel arrangements:

(a) Full panel using field sequential color. This is similar to FIG. 31. If the 2D display has a frame rate of 60 Hz, then the frame rate of as3D mode is 30 Hz.

(b) 3 sub-panels on a SLM using Pattern Illumination and sub-panel superimposition. Because 3 sub-panels are used, the effective frame rate is three times of case (a), i.e. 90 Hz.

(c) 2 sub-panels on a SLM applying Pattern Illumination and sub-panel superimposition (R, G/B). The effective frame rate is 3/2× of case (a), i.e. 45 Hz.

### 2.6 Numbers and Adjustments

Referring to FIG. 21(a), the relations of major parameters can be determined by trigonometry using lines of sight.

p/d=D/L (1)

pb/2p=L/(L+d) (2)

where p is the pitch between adjacent L- and R-image stripes, pb is the spacing between two adjacent barrier stripes, d is the spacing between the barrier panel 120 and the display 100, D is the distance between L- and R-eyes and L is the viewing distance.

For D˜65 mm, L˜300 mm (typical):

$$\begin{matrix}p / d \sim 1 / 5 & ( 3 ) \\ \begin{matrix}pb = 2 pL / ( L + d ) \\ = 2 pL / ( L + pL / D ) \\ = 2 p / ( 1 + p / D ) \sim 2 p \\ = ( 2 dDL / L ) / ( L + d ) \\ = 2 dD / ( L + d )\end{matrix} & ( 4 )\end{matrix}$$

TABLE 1
Typical dimensions and numbers of parallax barrier stripes for this
invention (Assuming 480 × 320 pixels (96 mm) or
320 × 240 pixels (64 mm), using TI 0.17″ DMD, D = 65 mm)

| | | | | | | # of |
|---|---|---|---|---|---|---|
| | # of | | | | | pixel in |
| Width of display | image | p | d (~5p) | | pb | stripe |
| (projected frame) | stripes | (mm) | (mm) | (1 + p/D) | (mm) | width |
| 64 mm (~2.5″) | 8 | 8 | 40 | 1.123 | 14.25 | 40 |
| | 16 | 4 | 20 | 1.062 | 7.53 | 20 |
| | 32 | 2 | 10 | 1.031 | 3.88 | 10 |
| 96 mm (~3.78″) | 8 | 12 | 60 | 1.123 | 14.25 | 40 |
| | 16 | 6 | 30 | 1.062 | 7.53 | 20 |
| | 32 | 3 | 15 | 1.031 | 3.88 | 10 |

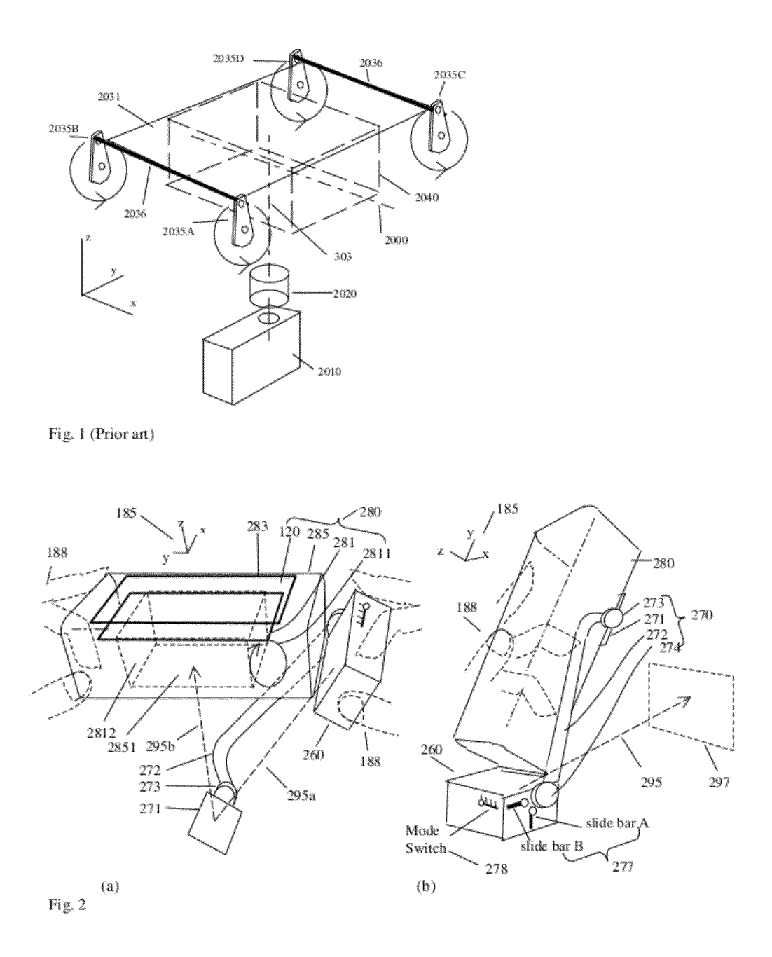

For simplicity, the values of pb and p are fixed. Yet different users may have different L and D. In such cases, a user can adjust “d” to accommodate different “L/D” values to satisfy equation (1). In a system of FIG. 2(a), “d” can be adjusted by manually changing the position of the screen 281 in the display volume.

Regarding the requirement of equation (2), from equation (4):

pb=2p/(1+p/D).

TABLE 2
Optimal pb value at different D (assuming L = 300 mm)

| | Width of display: 64 mm | Width of display: 96 mm |
|---|---|---|
| | # of image stripes: 16 | # of image stripes: 16 |
| optimal pb | (d = 20 mm) p = 4 mm | (d = 30mm) p = 6 mm |
| D = 55 mm | 7.458 mm | 7.458 mm |
| D = 65 mm | 7.536 | 7.536 |
| D = 80 mm | 7.619 | 7.619 |

The variation of optimal pb is about 0.08 mm, which is smaller than the size of one pixel (0.2 mm). Therefore, the resulted error is less than one pixel.

The above numbers also apply to the case of checker-board barrier panel.

### 2.7 Border Issue and Solutions

Referring to FIG. 33(a), when a viewer moves his head laterally away from the ideal position 20, the border area between two adjacent image stripes (991) becomes visible to the new eye position 20LA. Part of each R-image stripe becomes visible to L-eye and part of each L-image stripe visible to R-eye (FIG. 33(b), 991 and 992). Discontinuity of image across the border may be seen. There can be two solutions to this issue.

### 2.7.1 The Simple Solution: Alignment Marker

The simple solution provides a set of markers for the viewer. The viewer can easily realign the lines of sight using the markers as a reference.

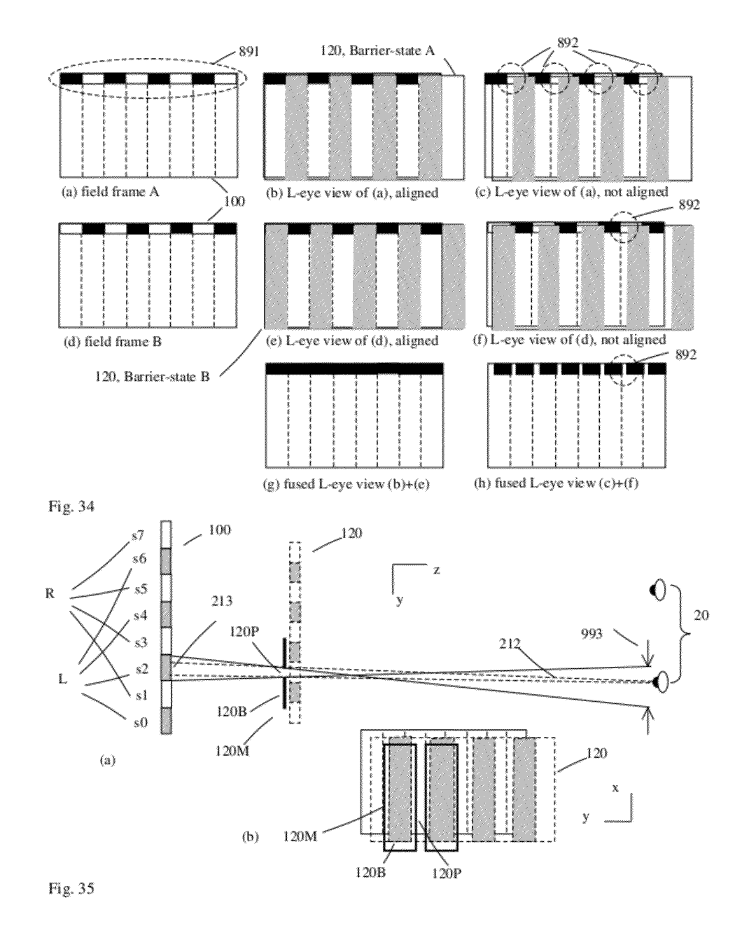

FIG. 34 illustrates the method of alignment markers. At the top (or bottom) 891 of each field frame, a horizontal band with black and white alternating markers is displayed. Each black (or white) marker marks the full width of an image stripe. When the alignment is good, one eye (say L-eye) sees only the black markers through the barriers (FIG. 34(b)). In the next field frame, the black and white markers switch positions according to Barrier-state B (FIG. 34(d)). L-eye still sees only the black markers (FIG. 34(e)). As a result, L-eye's fused view sees a full width black band at the top of the display (FIG. 34(g)).

When the alignment is not good, a portion of each white marker becomes visible 892. This happens in both field frames A and B (FIGS. 34(c) and (f). As a result, L-eye's fused view sees a broken band 892, as shown in FIG. 34(h).

When viewing markers for alignment, the viewer uses only one eye to see the markers.

In the current example, if R-eye is used, good alignment will show a full-white band and off-alignment will also show a broken band (a negative image of (h)).

The function of alignment markers can be programmed in the software or firmware the display and can be opened or closed by the viewer. Because the user holds the display system in hands, the user can become used to the coordination between hands and eyes without difficulty or discomfort.

### 2.7.2 The Complicated but Fundamental Solution:

This solution uses barrier stripes wider than viewing apertures. This allows increased tolerance for alignment of lines of sight.

FIG. 35(a) is similar to FIG. 33(a) except that the modified barrier panel 120M has barriers wider than viewing apertures. The narrower viewing aperture 120MP limits the width of visible area of a image stripe, 213. Thus, within a tolerance range 993, the border areas are not visible. FIG. 35(b) is a front view showing the wider barriers covering the border areas.

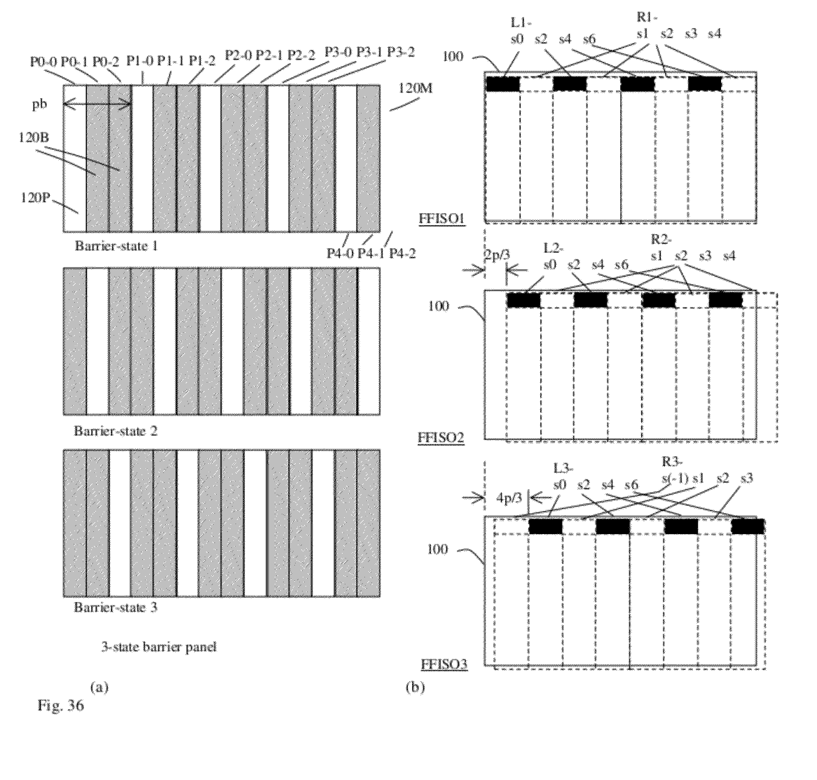

FIG. 36(a) illustrates the method to generate a set of wide position changing barriers. The panel has an array of shutter stripes. Every three adjacent shutter stripes are grouped as one group. For example, position p0-0, p0-1 and p0-2 are group #0. At any time, in every group, only one shutter at the same relative position is open. For example, in Barrier-state 1, only shutters in position Pi-0 (i=0, 1, 2, 3, 4) are open. Therefore, every two adjacent closed shutters form one “wide barrier”. In order to change position of the barriers, the positions of open shutters move across the panel. For example, in Barrier-state 2, the open shutter positions move to positions Pi-1 (i=0, 1, 2, 3, 4). In Barrier-state 3, the open shutter positions move to positions Pi-2 (i=0, 1, 2, 3, 4). From Barrier-state 1 to 3, the barriers (and the viewing apertures) appear to move from left to right, one stripe position (pb/3) at a time. In other words, the barrier panel has 3 states, instead of 2. As a result, the panel has 2:1 barrier-to-aperture width ratio at all time. Any area on the barrier panel is open for ⅓ of the time.

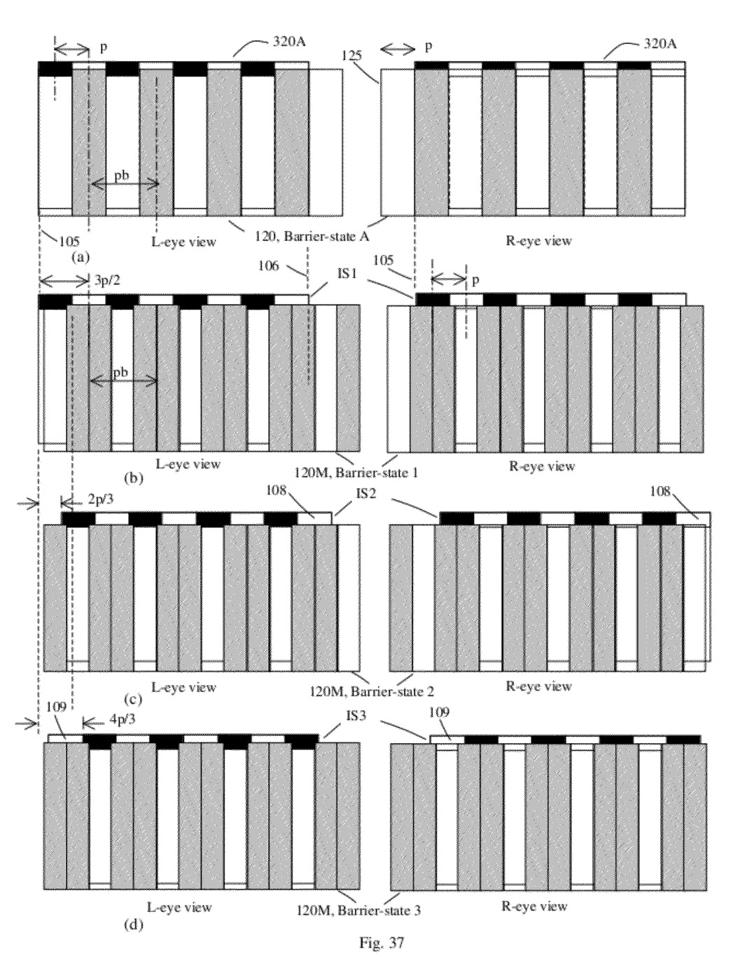

The image stripes displayed on the 2D display have to move together with the movement of the barriers. FIG. 37 illustrates the “movement” of L- and R-image stripes corresponding to the 3-state parallax barriers. FIG. 37(a) shows the view of image stripes through a 2-state barrier panel 120 for comparison. FIG. 37(b) shows the view of a set of image stripes (IS1) through Barrier-state 1. For convenience, the two cases use the same pitch of barriers pb. Therefore, the two cases also have the same the pitch of image stripes p. (When alignment is good, pb appears to be equal to 2p in the view.) The image stripes are also depicted with the black/white markers at top. Black markers indicate L-image stripes. White markers indicate R-image stripes. The left edge of the 2D display 105 is used as the reference for measuring positions of image stripes.

In FIG. 37(c), corresponding to Barrier-state 2, the image stripes move with their corresponding viewing apertures. Because the barriers move pb/3 to the right from Barrier-state 1 to Barrier-state 2, the image stripes (IS2) also move to the right by a distance of pb/3 relative to IS1, which corresponds to 2p/3 from edge 105.

Similarly, corresponding to Barrier-state 3, the image stripes (IS3) move to the right by a distance of 4p/3 from edge 105. (FIG. 37(d))

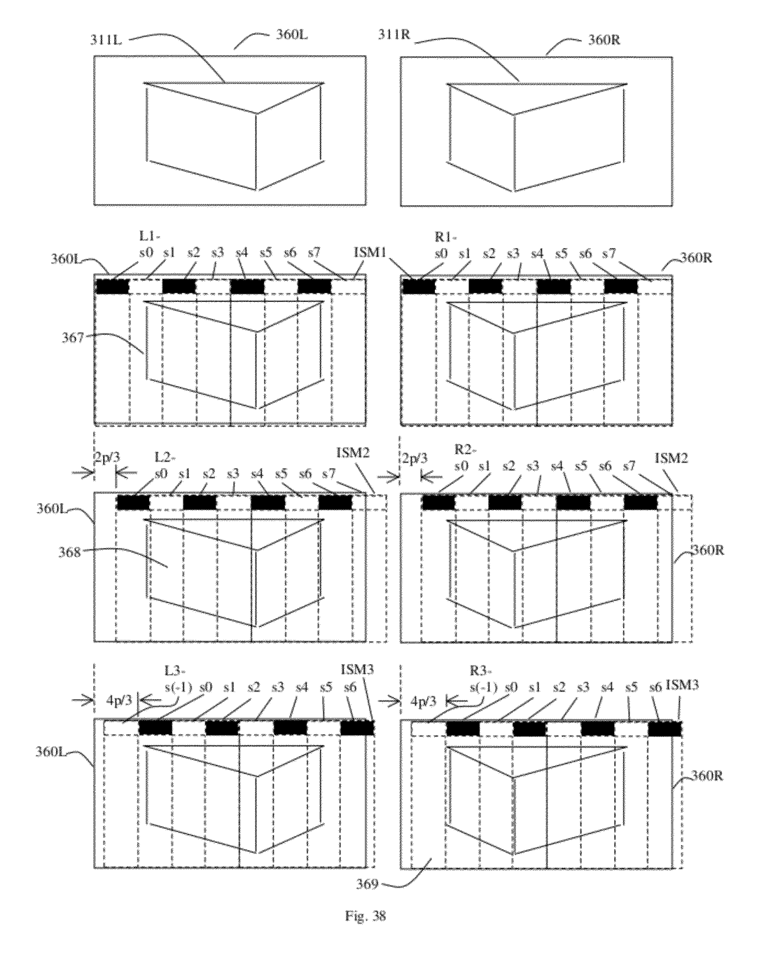

From above, a conceptual “image stripes mask” (ISM) can be defined and used to process image data in order to make field frames. The ISM is to be masked over the original stereoscopic image frame pairs in order to determine the division of image stripes. FIG. 38 illustrates 3 ISMs, each corresponding to a different Barrier-state, masking over an example of original stereoscopic frame pair 360R and 360L. The position of each ISM (i.e. 0, 2p/3 and 4p/3 relative to the left edge) comes from FIG. 37. A labeling system identifies the image stripes masked by the ISMs. For example, image stripe 367 is labeled as Li-s1 (meaning L-frame, ISM1, stripe #s1). Image stripe 368 is labeled as L2-s2 (L-frame, ISM2, str #s1). Image stripe 369 is labeled as R3-s(−1) (R-frame, ISM3, stripe #(−1)).

FIG. 36(b) illustrates field frame image stripes organization (FFISO) for the 3 successive field frames. These FFISOs represent the contents of the image stripes to be displayed in the 2D display for the 3 field frames. FFISO1-3 corresponds to Barrier-state 1-3 respectively. The labels of image stripes refer to the labels in FIG. 38. FFISO1-3 can be understood as a kind of image processing “operator” that processes original stereoscopic frame pairs into field frames.

Table 3 summarizes the conversion procedure of a sequence of original stereoscopic frame-pairs into as3D frames.

TABLE 3

| | | | | |
|---|---|---|---|---|
| OSFP 1 | --> operated by | --> giving Field Frame 1-1 | | |
| | FFISO1 | | | |
| | --> operated by | --> giving Field Frame 1-2 | | as3D |
| | FFISO2 | | {close oversize brace} | frame 1 |
| | --> operated by | --> giving Field Frame 1-3 | | |
| | FFISO3 | | | |
| OSFP 2 | --> operated by | --> giving Field Frame 2-1 | | |
| | FFISO1 | | | |
| | --> operated by | --> giving Field Frame 2-2 | | as3D |
| | FFISO2 | | {close oversize brace} | frame 2 |
| | --> operated by | --> giving Field Frame 2-3 | | |
| | FFISO3 | | | |
| . . . | | | | |

OSFP = original stereoscopic frame-pair

2.8 Incorporation into the Multiple-Mode Display

### DESIGN EXAMPLE 1

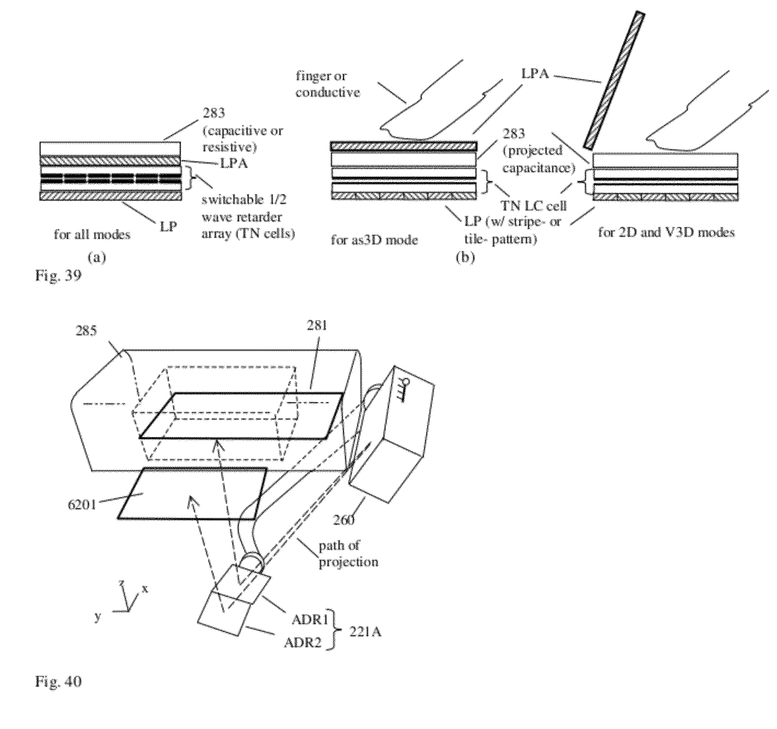

### (FIG. 39(a) Illustrates a Cross-Sectional Structure)

The parallax barrier panel 120 can be built either on the inside or on the outside of the system cover 285. The barrier patterns are built in the electrodes of a TN LC cell. In off-state, the panel is transparent, which allows operation in 2D mode or V3D mode. A transparent touch pad (resistive or projected capacitance) can be attached to the top.

### DESIGN EXAMPLE 2

### (FIG. 39(b) Illustrates a Cross-Sectional Structure)

In this design, the barrier patterns are made on polarizer LP. The analyzer LPA is removable. In as3D mode, the analyzer is closed down. In 2D and V3D mode, the analyzer is removed to make the unit transparent. A touch pad can be attached over the LC cell. In as3D mode, because the polarizer covers over the touch pad, the touch pad should use the projected capacitance type.

### DESIGN EXAMPLE 3

This design uses a barrier panel of FIG. 26(a) with a rotary retarder plate 730. In 2D and V3D modes, switching off TN LC cell and rotating the retarder plate by 45 degree makes the panel transparent.

### DESIGN EXAMPLE 4

This design uses a removable external barrier panel. Removing the barrier panel allows the system to operate in 2D and V3D mode.

### Part 3: Methods and Systems for Using Touch Pad for User-Image Interaction

### 3.1 Background and Problem to Solve

Tsao U.S. Pat. No. 6,765,566 describes a system that allows a user to use a hand-held manipulating device to interact directly with V3D images. The devices has a “virtual end” displayed in the V3D volume as a direct extension of the physical end held by hand. A “position tracking system” tracks the 3D position and orientation of the hand-held device. Such a system is generally expensive.

On the other hand, low-cost touch pads are now widely used on mobile devices and portable gaming devices. However, touch pads are designed to track only 2D positions.

The issue is to devise a means to use a traditional touch pad to perform user-image interaction in V3D and as3D displays.

### 3.2 Touch Pad Integrated in Convertible Multiple Mode Projection Display

See Part 2 Section 2.8.1.

### 3.3 Using A Projected Capacitance Touch Pad

This is the type used on iPhone, iPod Touch and iPad of Apple Inc. A Projected Capacitance (or Projective Capacitive) touch pad has a grid pattern of electrodes that can sense variation of capacitance at multiple grid points. A grounded conductor, such as a finger or a passive or active stylus, can cause capacitance variation by moving very close to or by touching the pad.

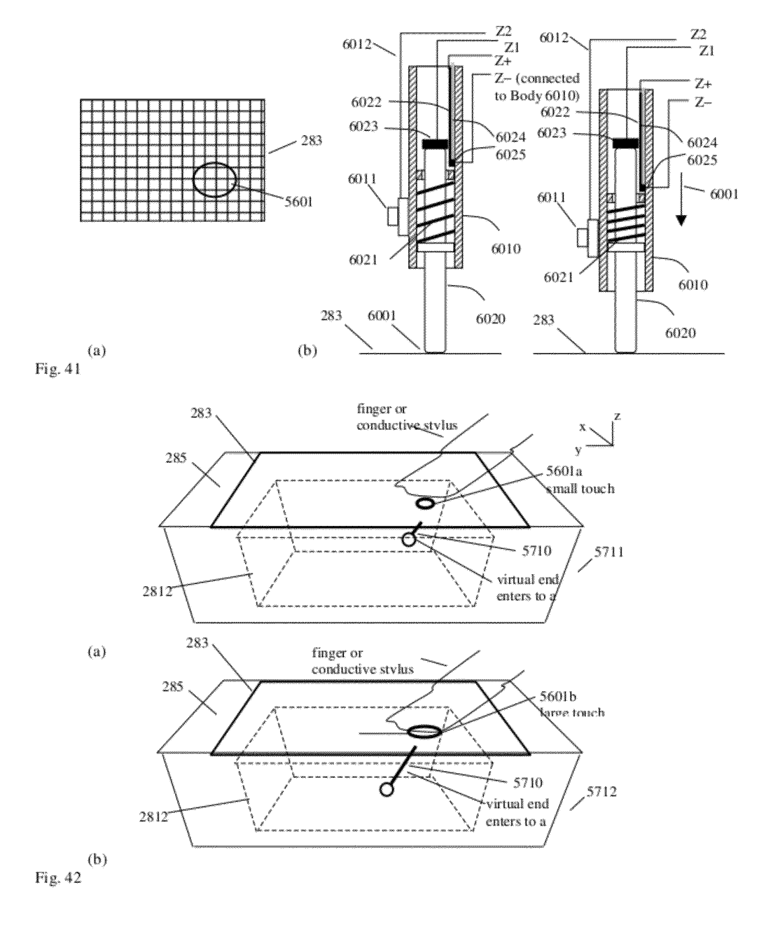

Using a touch pad that can detect dense multiple touch points, the total area of contact under one finger can be estimated by applying a software or firmware program to count the number of “touch” grids in the touch area 5601 (FIG. 41(a)). This total area can be used to represent a measure of “depth” into a 3D space. When a finger moves close and barely touch the pad, the touch pad detects a small touch area. A “virtual end” 5710 of the finger can be created by a software program and be displayed to show that the “virtual end” begins to enter the display volume (5711). When the finger touches the pad and increases the touch area, the “virtual end” moves deeper into the volume (5712). In this way, we have a 3 degree of freedom pointer. The touch location determines the (x, y) position and the touch area determines a z depth. See FIG. 42(a), (b).

The orientation of the finger can not be precisely sensed. However, the software program can give a estimation based on predetermined conditions selected by user. For example, if user selects to use right hand, or when the touch point is in the right portion of the screen, then the software program can assume that the “virtual end” points toward lower left direction. (FIG. 42(b)) If user selects to use left hand, or when the touch point is in the left portion of the screen, then the software program can assume that the “virtual end” points toward lower right direction. (FIG. 42(c)) User can also select a preferred inclination angle and direction for the virtual end. For example, in FIG. 42(c), the inclination angle/direction is “θm to the y-direction”. This inclination is particularly useful in as3D mode or in 2D (perspective 3D) mode. In those modes, user's viewing direction is fixed and is very close to the z-direction. Without inclination, the image of the virtual end can be blocked by user's finger or the stylus.

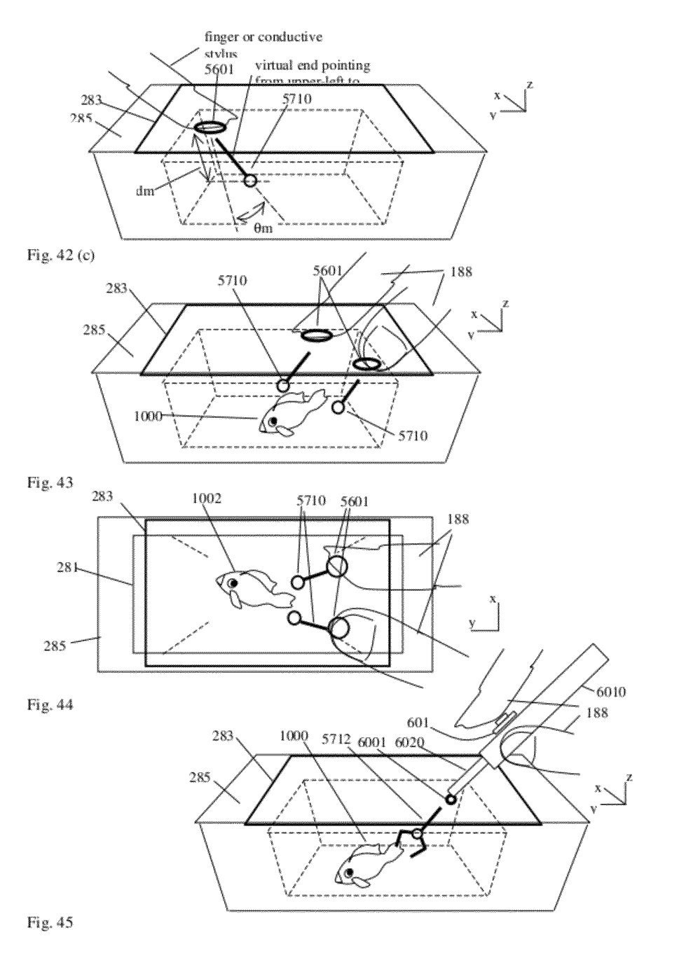

By using two fingers, the user can pick and drop objects (images) inside the V3D volume. (FIG. 43)

In general, this approach includes using any kind of touch pad capable of estimating area of touch or pressure of touch.

### 3.4 Using A Resistive Touch Pad

This is the type used on Nintendo DS. In general, a resistive touch pad is good at sensing 2D position of a single touch point only.

FIG. 41(b) shows the conceptual design of a “Z Stylus” capable of providing z positioning. The Z Stylus has two major portions, Body 6010 and Core 6020. The user holds the Body and touches the touch pad with the Core. When the user presses the Body downward 6001, the Core retracts. When the user moves the Body upward, a recoil spring 6021 pushes the core back to maintain contact with the touch pad. A potentiometer is built between the Body and the Core. A resistive stripe (resistor) 6022 is electrically insulated from the Body by an insulation layer 6024. One end 6025 of the resister is grounded (connected to Z− wire) and the other end is connected to Z+ wire. The Core has a contact point 6023 (Z1 wire) that slides along the resistive stripe when the Core moves. When a voltage is applied to wire Z+, (Z+, Z1 and Z−) becomes a voltage divider. Measuring voltage output at Z1 allows a computation of the position of the Core relative to the Body, which is the same measure of the distance between the Body and the touch point 6001. Therefore, we have a z position measurement. This is the same sensing mechanism used in a typical resistive touch pad. Combining a touch pad with the Z Stylus, we have a (x, y, z) 3D pointer. The Z Stylus can be used to control the insertion depth of a “virtual end” of the stylus into the V3D display volume or in the as3D virtual space, in ways similar to those described in FIG. 42.

In order to make a “Virtual Manipulator”, a control button 6011 and an additional wire Z2 (6012) are added. The user can hold the Body and uses the index finger to control the pushbutton. The control button (Z2) can be a simple push button (2-state) or can have analog output. A (game) software can use this Z2 status to control features in addition to the depth of the virtual end. For example, a pair of virtual tweezers or claws 5714 can be designed. By controlling Z2 signal, the user can grab and drop objects or action figures in a game. (FIG. 45)

Since resistive touch pads are frequently used with styluses, the “Z Stylus” can be easily incorporated into existing product designs. In general, the concept of the “Z Stylus” is not limited to the construction described in FIG. 41(b). The general concept is that the stylus has two parts and uses the relative displacement between the two parts to measure depth of touch.

The means for depth control and the concept of “virtual manipulator” described above can also be used in as3D mode or in 2D perspective presentation of 3D images. In these cases, the “virtual end” is displayed as an autostereoscopic image or a presentation in perspective view in 2D. FIG. 44 illustrates a top view of the system for such examples.

Part 4: System with Dual Screens

The system has a 2nd screen 6201, as shown in FIG. 40. The external reflector 221A has two reflective surfaces (ADR1 and ADR2) of slightly different angles. Each reflective surface covers different halves (6211, 6212) of the projection beam, when full panel is projected. One half of the full frame is projected to the main screen and the other half is projected to the 2nd screen. For convenience, this is called Divided Projection. The image source of the projector (e.g. a SLM) is divided into 2 sub-panels. One sub-panel corresponds to one half frame. The other sub-panel corresponds to the other frame. Different images or information can be displayed in the two different half frames. As a result, a single projector projects different contents to two different screens.

### LIST OF PARTS IN DRAWINGS

10 frame of coordinate system 10 indicates the orientation of the view of drawings
120 parallax barrier panel
188 user's hand/fingers
210, 211 line of sight
260, 2010 projector
280 display unit
281, 2031, 6201 screen
2812, 2040 display volume
283 touch pad
285 cover
890a, 890b direction of sliding
1000 volumetric 3D image
1002 auto-stereoscopic image
5710 virtual end image
AP, AP-G, AP-B, AP-R aperture plate
C1, C2 lens
C1-G, C1-B, C2-G, C2-B lens
DBS despeckle and beam shape unit
DR dichroic color filter
DR-G(RT) dichroic color filter green reflect (red pass)
DR-G(BT) dichroic color filter green reflect (blue pass)
DR-R, DRe-R dichroic color filter red reflect
DR-B, DRe-B dichroic color filter blue reflect
f1, f2 focal length
IL-R, IL-B, IL-G illumination beam, light ray (R, G and B respectively)
IM, IM-B imaging ray
IP-R, IP-G, IP-B illumination pattern
L1, L2, L4 lens
L1-B, L2-B lens
LED-R, LED-G, LED-B light source, esp. LED light source
LP, LPA polarizer
LP-S-B, LP-S-G, LP-S-R, LP-S, LP-F, LP-S light pipe
PL projection lens
R1, R2, R3 reflector
S-R, S-G, S-B small area diverging light source
SLM spatial light modulator
SP, SP1 etc. sub-panel of SLM

1. System of projection display including the following features:
said system includes a spatial light modulator as image source, an illumination unit for illuminating said spatial light modulator, and a projection lens;
said system includes a sub-panel projection mode, and wherein
in said sub-panel projection mode, said spatial light modulator operates in a sub-panel display mode, wherein
in said sub-panel display mode, the display area of said spatial light modulator is divided into several sub-panels, and each said sub-panel displays image belonging to a different primary color component of a color image;
optical layout of said system includes a sub-panel projection layout, wherein
said sub-panel projection layout includes a set of dichroic reflectors at the output end of said projection lens, said set of dichroic reflectors aligning the centers of images of projected sub-panels and superimposing image contents of different said sub-panels into one color image;
said illumination unit includes a full-panel illumination mode, wherein
in said full-panel illumination mode, a light source illuminates the display area of said spatial light modulator with a white light;
said system further includes a movable screen and a foldable reflector unit, wherein
said foldable reflector unit can guide a projection beam from said projection lens onto said movable screen or to an external target;
said movable screen can be in a stationary state or in a moving state when receiving projection.

2. System of claim 1, wherein
said system further includes a convertible projection means for conversion between said sub-panel projection mode and a full-panel projection mode, and wherein
said convertible projection means switches optical layout of said system between said sub-panel projection layout for said sub-panel projection mode and a full-panel projection layout for said full-panel projection mode, wherein
said full-panel projection layout includes a plain reflector at the output end of said projection lens;
said convertible projection means further switches said spatial light modulator between said sub-panel display mode and a full-panel display mode, and wherein
in said full-panel display mode, said spatial light modulator displays full panel images.

3. System of claim 2, wherein
said illumination unit includes a convertible illumination means for conversion between a sub-panel illumination mode and said full-panel illumination mode, and wherein
in said sub-panel illumination mode, said illumination unit illuminates each of said sub-panels with a light of different primary color;

4. System of claim 3, wherein
said convertible illumination means converts optical layout of said illumination unit between a sub-panel illumination layout and a full-panel illumination layout, and wherein
said sub-panel illumination layout includes the following optical components, in sequence of light passage: a 1st collecting lens(L1), a 2nd light collecting lens (L2), an aperture plate, a 1st intermediate lens (C1), a set of dichroic reflectors, and a 2nd intermediate lens (C2);
said full-panel illumination layout includes the same optical components as said sub-panel illumination layout except that said 2nd collecting lens (L2) and said aperture plate are replaced by a third collecting lens (L2a), and said set of color filtering reflectors is replaced by a single plain reflector;
said convertible illumination means includes an opto-mechanical mechanism that is movable between two positions.

5. System of claim 4, wherein
said 2nd intermediate lens (C2) projects the center of said 1st intermediate lens (C1) to a position at or near the projection lens;
in said sub-panel illumination layout, said 2nd collecting lens (L2) converges illumination light to a position near the center of said 1st intermediate lens (C1);
in said full-panel illumination layout, said 3rd collecting lens (L2a) converges illumination light to a position at or near the center of said 1st intermediate lens (C1).

6. System of claim 3, wherein
said light source includes 3 separated LED sources, each of a different primary color;
said convertible illumination means converts optical layout of said illumination unit between a sub-panel illumination layout and a full-panel illumination layout, wherein
said sub-panel illumination layout includes the following optical components, in sequence of light passage: 3 1st collecting lenses (C1) for collecting light from said 3 LED source, a set of color filtering reflectors for combining light of different primary colors, and a lens (C2) for projecting images of said LED sources onto said spatial light modulator, and wherein
each said LED source is aligned relative to one of said collecting lens (C1) and is projected to cover a specific said sub-panel;
said full-panel illumination layout includes the same optical components as said sub-panel illumination layout except that 3 2nd collecting lenses (C1a) replace said 3 1st collecting lens (C1), and wherein
each said 2nd collecting lenses (C1a) is aligned relative to one of said 3 LED sources and each said LED source is projected to cover full panel of said spatial light modulator;
said convertible illumination means includes an opto-mechanical mechanism that is movable between two positions.

7. System of claim 3, wherein
said light source includes a number of closely packed LED sources;
said convertible illumination means converts optical layout of said illumination unit between a sub-panel illumination layout and a full-panel illumination layout, where in
said sub-panel illumination layout includes a 1st collecting lenses (C1) and a lens (C2) for projecting images of said LED sources onto said spatial light modulator;
said full-panel illumination layout includes the same optical components as said sub-panel illumination layout except that a 2nd collecting lens (C1a) replaces said 1st collecting lens (C1) and a light integrator combines light of different colors from said LED sources into said white light;
said convertible illumination means includes an opto-mechanical mechanism that is movable between two positions.

8. System of claim 3, wherein
said light source includes 3 sets of closely packed multiple LED sources, each said set having a different primary color, and each LED source in one said set illuminating one different said sub-panel, and wherein
in said sub-panel illumination mode, only one LED source in each said set is switched on and each said sub-panel is illuminated by one LED source from a different said set;
in said full-panel illumination mode, all LED sources in each said set are switched on to illuminate all said sub-panels.

9. System of claim 3, wherein
said light source includes a number of laser sources of different primary colors;
said convertible illumination means converts optical layout of said illumination unit between a sub-panel illumination layout and a full-panel illumination layout, wherein
said full-panel illumination layout includes a 1st set of color filtering reflectors for combining laser beams of different primary colors into a white beam and a beam expander (lenses E1a and E2) for expanding beam size to cover full panel of said spatial light modulator;
said sub-panel illumination layout includes a lens E1 replacing said lens E1a and a 2nd set of color filtering reflectors for converting laser beams into an array of closely packed beams of different primary colors, each beam covering a different said sub-panel of said spatial light modulator, wherein
said lens E1 reduces the expanding ratio of the beam expander;
said 2nd set of color filtering reflectors is an additional set or a replacement set of said 1st set.
said convertible illumination means includes an opto-mechanical mechanism that is movable between two positions.

10. System of claim 3, wherein said movable screen includes a rotary reciprocating mechanism.

11. System of claim 10, wherein said system further includes a parallax barrier panel, wherein
said parallax barrier panel is capable of switching between a transparent state and an opaque state in selective areas of the panel, thereby creating an array of viewing apertures and barriers that can change their relative positions on the panel.

12. System of claim 10, wherein said system further includes a touch pad having a depth control means, wherein
said depth control means includes one of the following means:
(1) a computer program for estimating touch area under a touch position and converting said touch area into a measure of depth, or
(2) a z-stylus xxxx

13. System of claim 10, wherein said system further includes a 2nd screen and said foldable reflector unit includes a reflector having two reflecting surfaces of slightly different angles for reflecting half of said projection beam onto said movable screen and the other half of said projection beam onto said 2nd screen.

14. System of autostereoscopic display comprising:
an image display and
a parallax barrier panel;
wherein said parallax barrier panel is capable of switching between a transparent state and an opaque state in selective areas of the panel, thereby creating an array of viewing apertures and barriers that can change their relative positions on the panel.

15. System of claim 14, wherein
said parallax barrier panel presents a set of barrier-states in sequence repeatedly, wherein in each barrier-state of said set of barrier-states, said viewing apertures cover a different area of the panel, and in combination, said viewing apertures presented in all barrier-states of said set of barrier-states cover full area of the panel;
said image display displays a set of field frames in sequence corresponding to the sequence of the barrier-states presented by said parallax barrier panel, wherein
said field frames, when viewed through said parallax barrier panel by left eye, fuse into a full-frame left-eye image that is visible only to left eye, and when viewed through said parallax barrier panel by right eye, fuse into a full-frame right-eye image that is visible only to right eye, and said left-eye image and said right-eye image form an autostereoscopic image.

16. Method of interaction with computer generated 3D images using a touch pad, said method including the following steps:
applying a depth control means at at least one touch position (x, y) on said touch pad to provide a measure of depth (d) to be used corresponding to said touch position for the interaction;
computing position and orientation of a virtual end to be displayed according to the coordinates of said touch position, said measure of depth and predetermined inclination parameters, wherein said inclination parameters include an inclination angle and an inclination direction, which are determined by user selection;
displaying said virtual end according to the computed position and orientation;
providing a computer program for interaction between said virtual end and said 3D images.

17. Method of claim 16, wherein
said touch pad is capable of sensing multiple touch points on the pad;
said depth control means includes a computer program for computing total number of touch points adjacent to said touch position in order to estimate a touch area, and said measure of depth is estimated from said touch area.

18. Method of claim 16, wherein said depth control means includes a Z-stylus.
